(19) United States
(12) Patent Application Publication
(10) Pub. No.: US 2024/0116816 A1
(43) Pub. Date: Apr. 11, 2024

(54) DILUTION-STABLE AQUEOUS COMPOSITIONS FOR THE MASS HYDROPHOBIZATION OF MINERAL BUILDING MATERIALS

(71) Applicant: Evonik Operations GmbH, Essen (DE)

(72) Inventors: Anke Reinschmidt, Essen (DE); Nino Bagus, Essen (DE); Matthias Lobert, Essen (DE); Christian Havekost, Dorsten (DE)

(73) Assignee: Evonik Operations GmbH, Essen (DE)

(21) Appl. No.: 18/257,780

(22) PCT Filed: Dec. 14, 2021
(86) PCT No.: PCT/EP2021/085614

§ 371 Date: Jun. 15, 2023

(30) Foreign Application Priority Data
Dec. 18, 2020 (EP) 20215314.4

(51) Int. Cl. C04B 24/42; C04B 14/06; C04B 28/02; C04B 40/00; C08G 77/18

(52) U.S. Cl. CPC C04B 24/42; C04B 14/06; C04B 28/02; C04B 40/0039; C08G 77/18; C04B 2103/406

(57) ABSTRACT

Dilution-stable compositions are useful for the mass hydrophobization of mineral building materials. The compositions contain at least one organosiloxane (A), at least one emulsifier (B), and water. The organosiloxane (A) has SiC-bonded C₂-C₆ alkyl radicals and SiC-bonded C₇-C₁₈ alkyl radicals. Processes can be used for preparing the organosiloxane (A). Hydraulically setting compositions contain the organosiloxane (A).

The present invention relates to aqueous compositions based on organosilicon compounds for bulk hydrophobization of mineral construction materials.

The use of organosilicon compounds, especially silanes and siloxanes, for hydrophobizing impregnation and bulk hydrophobization of mineral and organic construction materials, especially with the aim of structural protection, is sufficiently well known.

U.S. Pat. No. 2,887,467 A describes, for example, a process for preparing glycol-substituted organosiloxanes of low molecular weight. This involves reacting a water-insoluble, non-water-dispersible methylslsesquioxane composed of units of the formula [CH₃SiO_{3/2}] with ethylene glycol at a temperature of about 150° C. The intention here is preferably to use 3 mol of glycol per mole of silicon atoms of the methylslsesquioxane. The product obtained is water-soluble and can be used as hydrophobizing agent for brickwork. There is no disclosure of organosiloxanes having both SiC-bonded C₂-C₆-alkyl radicals and SiC-bonded C₇-C₁₆-alkyl radicals.

DE 1 076 946 (examined and published text) discloses a process for preparing organopolysiloxanes that are suitable for hydrophobization and finishing and are insoluble in benzene but soluble in water in all ratios, characterized in that ethylene glycol is reacted with a mixture of alkylalkoxysilanes containing, by weight, 50 to 100 mole percent of a monoalkyltrialkoxysiane, 0 to 50 mole percent of a trialkylalkoxysilane, 0 to 10 mole percent of a dialkyldialkoxysilane and 0 to 10 mole percent of a tetraalkoxysilane (the silicon-bonded alkyl groups of which consist of methyl and/or ethyl radicals, and the alkyl group of the alkoxy radical of which consists of a radical of a monohydric alcohol having 1 to 5 carbon atoms), wherein more than one hydroxyl group of the ethylene glycol per alkoxy group is present in the mixture of the alkylalkoxysilanes, in the presence of an acidic catalyst while heating to a temperature below 100° C., with simultaneous removal of aliphatic monohydric alcohols released. The silicon-bonded hydrocarbon radicals possessed by the organopolysiloxanes here are said to be methyl and/or ethyl radicals. The organopolysiloxanes are said to have good storability only in the undiluted state. The addition of water is therefore supposed to occur only a short time before use because the period of usability of the organopolysiloxanes prepared decreases with time after the water has been added. There is no disclosure of organosiloxanes having both SiC-bonded C₂-C₆-alkyl radicals and SiC-bonded C₇-C₁₆-alkyl radicals.

DE 10 2004 058 977 A1 discloses a water-repellent gypsum composition comprising a glycol-functional siloxane mixture preparable by the reaction of one molar equivalent of alkyltrihalosilane or alkyltrialkoxysilane with at least 2.5 molar equivalents of a glycol or mixture of glycols. Alkyl radicals described here are monovalent, optionally halogen-substituted C₁-C₁₅ hydrocarbon radicals. But preference is given here to short-chain alkyl radicals such as C₁-C₆-alkyl radicals, especially the methyl radical and the ethyl radical. There is no disclosure of organosiloxanes having both SiC-bonded C₂-C₆-alkyl radicals and SiC-bonded C₇-C₁₈-alkyl radicals.

DE 10 2005 019 254 A1 discloses aqueous construction material coating compositions comprising a glycol-functional organosilicon compound as hydrophobizing additive, at least 10 g of which is soluble in 100 g of water at 20° C. It is stated that the glycol-functional organosilicon compounds can be used in emulsifier-free-form as aqueous solutions. It is further disclosed that the organosilicon compound is to have silicon-bonded monovalent, optionally halogen-substituted C₁-C₆ hydrocarbon radicals. There is no disclosure of organosiloxanes having both SiC-bonded C₂-C₆-alkyl radicals and SiC-bonded C₇-C₁₆-alkyl radicals.

WO 2006/097206 A1 describes a process for hydrophobizing substrates with organosilicon compounds preparable by reacting one molar equivalent of silane selected from hydrocarbyltrihalosilane, hydrocarbylkrihydrocarboxysiane or mixtures thereof with 2.0-2.99 molar equivalents of a glycol or a mixture of glycols. The organosilicon compounds are said to be water-soluble or readily water-dispersible. Silicon-bonded hydrocarbon radicals of the silane used that are disclosed are C₁-C₁₅ hydrocarbon radicals. Particular preference is given here to the unsubstituted C₁-C₆-alkyl radicals, especially the methyl radical and the ethyl radical. There is no disclosure of organosiloxanes having both SiC-bonded C₂-C₆-alkyl radicals and SiC-bonded C₇-C₁₆-alkyl radicals.

WO 2013/053609 A1 describes a process for bulk hydrophobization of substrates with organosilicon compounds that are solid at 20° C. and are preparable by reacting one molar equivalent of silane selected from hydrocarbyltrihalosilane, hydrocarbyltrihydrocarboxysilane or mixtures thereof or partial hydrolysates thereof with polyhydroxyl compounds in such a molar ratio that 0.3 to 1.3 molar equivalents of hydroxyl radicals are present per molar equivalent of halogen or hydrocarboxy radical. The organosilicon compounds are said to be stable and have very good hydrophobization, but at the same time to be solid and have only low water solubility. SiC-bonded hydrocarbon radicals of the used silane are disclosed to be C1-C15 hydrocarbon radicals. Particular preference is given here to unsubstituted C₁-C₆-alkyl radicals, especially the methyl radical and the ethyl radical. There is no disclosure of organosiloxanes having both SiC-bonded C₂-C₆-alkyl radicals and SiC-bonded C₇-C₁₆-alkyl radicals.

WO 00/46167 describes a firm aqueous cream that can be used for hydrophobizing impregnation or priming of mineral construction materials. The cream contains components (A) that are selected from (A1) C₁-C₂₀-alkyl-C₂-C₆-alkoxysilanes and (A2) organopolysiloxane containing alkoxy groups, (C) emulsifier and (D) organic solvent. The organopolysiloxanes (A2) may have identical or different monovalent, optionally halogen-substituted, SiC-bonded C₁-C₂₀ hydrocarbon radicals. Particular preference is given to the unsubstituted C₁-C₁₂-alkyl radicals and the phenyl radical. What is described is, for example, an organopolysiloxane of the empirical formula (CH₃)_{0.7}(isooctyl)_{0.3}(OCH₃)_{0.6}SiO_{1.2}. In addition, it is possible to use organopolysiloxanes (B2). These bear nitrogen-containing and nitrogen-free radicals. Nitrogen-free radicals described are optionally halogen-substituted, SiC-bonded C₁-C₂₀ hydrocarbon radicals. Especially preferred are the methyl radical and the isooctyl radical. There is no disclosure of organosiloxanes having both SiC-bonded C₂-C₆-alkyl radicals and SiC-bonded C₇-C₁₈-alkyl radicals.

WO 2012/138589 A1 discloses aqueous dispersions of organosilicon compounds, processes for production thereof and the use thereof, especially for hydrophobizing impregnation and bulk hydrophobization of mineral and organic construction materials. Organosiloxanes used in the production have identical or different monovalent, SiC-bonded, optionally substituted hydrocarbon radicals. These hydrocarbon radicals are preferably hydrocarbon radicals that are optionally substituted by oxygen- or nitrogen-containing groups and have 1 to 18 carbon atoms, more preferably alkyl radicals having 1 to 18 carbon atoms or aromatic hydrocarbon radicals having 6 to 9 carbon atoms, most preferably methyl, n-hexyl, n-heptyl, n-octyl, isooctyl, n-dodecyl, phenyl and ethylphenyl radicals, especially preferably the methyl radical. There is no disclosure of organosiloxanes having both SiC-bonded C₂-C₆-alkyl radicals and SiC-bonded C₇-C₁₈-alkyl radicals.

EP 1 982 964 A1 relates to the use of a water-dispersible, -redispersible or -soluble mixture or an aqueous composition for the protection of substrates from corrosion, wherein the mixture or composition is based on at least one water-soluble organic polymer and at least one organosilicon compound. The organosiicon compound disclosed is an oligomer mixture of propylethoxysiloxanes.

EP 3 243 807 A1 relates to the use or an aqueous oil-in-water emulsion containing a propylethoxysilane oligomer mixture or a mixture of a propylethoxysliane oligomer mixture and octyftriethoxysilane in a weight ratio of 3:1 to 1:3, at least one emulsifier or an emulsifier system, and at least a content of a 2-aminoethanol and water as an addition, in the production of hydraulically setting cement mixtures such as mortar, screed or concrete for reduction of the shrinkage characteristics. The emulsion is additionally described as hydrophobizing. There is no disclosure of organosiloxanes having both SiC-bonded C₂-C₆-alkyl radicals and SiC-bonded C₇-C₁₈-alkyl radicals.

CN 103449750 B relates to an impregnating agent or sealing agent that can be applied to concrete, tiles and mortar. The impregnating agent is produced by dissolving an emulsifier, a polyvinylalcohol, a silane adhesion promoter and aluminium sulfate in water at 50 to 70° C. In water while stirring, and then adding alkyltriethoxysilanes while stirring, with adjustment of the pH to 3 to 6, followed by addition of further water until a stable emulsion is obtained. What are described here are more particularly mixtures of two or more alyltriethoxysilanes selected from butyltriethoxysilane, octyltriethoxysilane, decyltriethoxysilane and tetradecyltriethoxysilane. There is no disclosure of organosiloxanes having both SiC-bonded C₂-C₆-alkyl radicals and SiC-bonded C₇-C₁₈-alkyl radicals.

CN 103819127 A relates to an impregnating agent for cementitious products such as mortar and concrete. The impregnating agent contains octyltriethoxysilane, a methylsilicone resin and an emulsifier. For preparation of the methylsilicone resin present, methyltrlethoxysilane and cyclic dimethylsiloxane are equilibrated in the presence of trifluoromethanesulfonic acid as catalyst and then reacted with water, with distillative removal of the ethanol released. There is no disclosure of organosiloxanes having both SiC-bonded C₂-C₆-alkyl radicals and SiC-bonded C₇-C₁₈-alkyl radicals.

CN 105111932 A describes an impregnating agent for construction materials, wherein the impregnating agent is a reaction product of a composition containing nonionic and anionic emulsifiers, water, cyclic silicones and alkoxysilanes. Cyclic silicones used are dimethylcyclosiloxanes. The alkoxysilanes used have SiC-bonded C₁-C₁₈-alkyl radicals. More particularly, methyltrimethoxysilane, propyrtrimethoxysilane and propyltriethoxysilane are used. There is no disclosure of organosiloxanes having both SiC-bonded C₂-C₆-alkyl radicals and SiC-bonded C₇-C₁₈-alkyl radicals.

CN 105293992 A relates to impregnating agents for wood and to preparation thereof. The impregnating agent is prepared from a silicone resin prepolymer, a mixture of a hydroxy-functional silicone oil and a dimethylsilicone oi, an organosilicon-based crosslinker, long-chain alkylsilanes, organosilicon-based quaternary ammonium salts, organic solvents, auxiliaries and nanofillers. The silicone resin polymer is a reaction product formed inter alia from propyltriethoxysilane, octyltriethoxysilane, decamethylcyclopentasiloxane (D5), ethanol and water. The silicone resin prepolymer is subsequently reacted further with a reaction product formed from a silicone oi and triethoxysilane as crosslinker and further components. The solvent used is ethanol. The impregnating agent is thus not an aqueous composition. There is no disclosure of compositions also comprising at least one emulsifier (B) and water as well as at least one organosiloxane having SiC-bonded C₂-C₆-alkyl radicals and SiC-bonded C₇-C₁₈-alkyl radicals.

CN 107556050 A describes a silane paste impregnating agent containing 40-70% by weight of an alkylalkoxysilane, 10-40% by weight of a reactive siloxane oligomer, 4-15% by weight of a cyclic siloxane, 0.5-2% by weight of a surface-active substance and 10-20% by weight of water. The reactive siloxane oligomer is preferably a hydroxy- or alkoxy-terminated polydimethylsiloxane. The alkylalkoxysilane is a mixture of a trifunctional alkylalkoxysilane and a difunctional alkylalkoxysilane. Preferably, the trifunctional alkylalkoxysilane is propyltriethoxysilane, n-butyltriethoxysilane, n-octyltriethoxysilane, cetyltriethoxysilane or a combination of these compounds, and the difunctional alkylalkoxysilane is methylalkyldimethoxysilane, methylalkyldiethoxysilane or a combination of these compounds, where the alkyl group is isobutyl, n-octyl, dodecyl or phenyl. There is no disclosure of siloxanes having both SiC-bonded C₂-C₆-alkyl radicals and SiC-bonded C₇-C₁₈-alkyl radicals.

DD 137720 describes a base-catalysed process for preparing alkoxyalkylpolysiloxanes. In the first step of the process, alkylalkoxysilanes are equilibrated in the presence of KOH with dimethylcyclosiloxane to give species of higher molecular weight. In the second step, controlled condensation is achieved by the addition of defined amounts of water with simultaneous distillative removal of ethanol, optionally followed by a further equilibration step. There is no disclosure of siloxanes having both SiC-bonded C₂-C₆-alkyl radicals and SiC-bonded C₇-C₁₈-alkyl radicals.

WO 2006/081892 A1 discloses aqueous oil-in-water emulsions containing functional alkoxysilanes and/or condensed oligomers thereof and/or organoalkoxysiloxanes, at least one emulsifier and water. The emulsions may be used for hydrophobization of porous mineral construction materials. The aqueous emulsions are said to be sufficiently stable in concentrated form and even after simple dilution with water. This is achieved by a controlled droplet size distribution. The presence of oligomers is said to improve the emulsification characteristics of the oil phase, and hence smaller droplet diameters are said to be achievable in the emulsifying of alkoxysilanes. Examples described include emulsions containing octyltriethoxysilane and propyltriethoxysilane oligomers having an oligomerization level of 2 to 4. There is no disclosure of organosiloxanes having both SiC-bonded C₂-C₆-alkyl radicals and SiC-bonded C₇-C₁₈-alkyl radicals.

The provision of compositions based on organosilicon compounds for impregnation and bulk hydrophobization of mineral and organic construction materials is obviously a major challenge. The compositions should firstly show good hydrophobizing action, which requires the use of hydrophobic organosilicon compounds. The composition should secondly be liquid, in order to enable simple processing and use, but for reasons of protection of the environment and health and from a safety point of view (e.g. combustibility) should at the same time also contain a minimum level of organic solvents. In this respect, aqueous compositions are preferable. On account of the naturally low water solubility of the hydrophobic organosilicon compounds, however, aqueous compositions are not homogeneous without further additives. In order to prepare aqueous compositions based on hydrophobic organosilicon compounds that do not show any phase separation visible to the naked eye, emulsifiers are therefore used. In this way, it is possible to obtain homogeneously milky/cloudy emulsions/dispersions. However, separation is apparent after prolonged storage even in the case of these compositions. This effect is particularly marked in the case of highly diluted compositions. i.e. compositions having a high water content. High storage stability and adequate dilution stability can be achieved, for example, through relatively high amounts of emulsifier. But this is likewise undesirable since the emulsifiers have an adverse effect on the properties of the construction materials. Emulsifiers can additionally also have an unfavourable effect on the setting characteristics of hydraulic binders, which have an adverse effect on mechanical properties, lead to discolouration and reduce the water-repellent properties of the construction materials. Moreover, they can be washed out in conjunction with rainwater or soil moisture, with leaching of the hydrophobizing agents. A further option would be to increase the viscosity of the continuous phase of the emulsion, for example using thickeners. However, an elevated viscosity would be unproductive taking account of the further use and handling which is customary in practice. In summary, it can thus be stated that a significant problem with emulsions containing organosilicon compounds such as silanes or siloxanes and/or equilibrates or condensates thereof is their inadequate storage stability and dilution stability.

There was thus a need for compositions based on organosilicon compounds that show good hydrophobizing action but at the same time show high storage stability and dilution stability.

The problem addressed by the present invention was therefore that of overcoming at least one disadvantage of the prior art. There was a particular need for compositions based on organosilicon compounds that show good hydrophobizing action and at the same time show high storage stability and dilution stability.

It has now been found that, surprisingly, this problem is solved by a composition comprising at least one organosiloxane (A), at least one emulsifier (B) and water in which the organosiloxane (A) present has SiC-bonded C₂-C₆-alkyl radicals and SiC-bonded C₇-C₁₈-alkyl radicals.

More particularly, it has been found here that, surprisingly, organosiloxanes bearing both SiC-bonded C₂-C₈-alkyl radicals and SiC-bonded C₇-C₁₈-alkyl radicals lead to higher storage stability and also dilution stability than comparable organosiloxanes that differ merely in that they either do not bear SiC-bonded C₂-C₆-alkyl radicals or do not bear SiC-bonded C₇-C₁₈-alkyl radicals.

The invention therefore firstly provides a composition comprising at least one organosiloxane (A), at least one emulsifier (B) and water, characterized in that the organosiloxane (A) has SiC-bonded C₂-C₆-alkyl radicals and SiC-bonded C₇-C₁₈-alkyl radicals.

The invention further provides a process for preparing organosiloxanes (A), preferably for preparing the composition according to the invention, comprising a process step in which a reaction mixture composed of
i. at least one C₂-C₆-alkylalkoxysilane and/or at least one C₂-C₆-alkylalkoxysiloxane, preferably at least one C₂-C₆-alkylalkoxysiloxane, especially a propyltriethoxysilane oligomer mixture.
ii. at least one C₇-C₁₈-alkylalkoxysilane and/or at least one C₇-C₁₈-alkylalkoxysiloxane, preferably at least one C₇-C₁₈-alkylalkoxysilane, especially octyltriethoxysilane,
iii. water,
iv. preferably at least one mono- or polyfunctional C₂-C₁₀ alcohol,
v. preferably at least one cyclic dimethylsiloxane,
vi. at least one tetraalkylammonium hydroxide, preferably tetrabutylammonium hydroxide,
vii. at least one superacid, preferably trifluoromethanesulfonic acid,
viii. and optionally further substances
   is converted.

The invention still further provides the use of the composition according to the invention as dilution-stable hydrophobizing agent.

The invention still further provides a hydraulically setting composition comprising the following components:
a) at least one hydraulic binder, preferably cement,
b) at least one composition according to the invention,
c) preferably at least one admixture selected from the group consisting of sand, gravel, limestone and chalk.
d) preferably additional water.

Advantageous configurations of the invention are specified in the subordinate claims, the examples and the description. Furthermore, it is explicitly pointed out that the disclosure relating to the subject-matter of the present invention includes all combinations of individual features of the present or subsequent description of the invention and of the claims. More particularly, embodiments of one subject of the invention are also applicable mutatis mutandis to the embodiments of the other subjects of the invention.

The subjects of the invention and their preferred embodiments are described by way of example below without any intention that the invention be confined to these illustrative embodiments. Where ranges, general formulae or compound classes are specified below, these are intended to include not only the corresponding ranges or groups of compounds which are explicitly mentioned but also all subranges and subgroups of compounds which can be obtained by removing individual values (ranges) or compounds. Where documents are cited in the context of the present description, the entire content thereof is intended to be part of the disclosure content of the present invention.

Where average values are reported hereinafter, these values are numerical averages unless stated otherwise. Where measurement values, parameters or material properties determined by measurement are reported hereinafter, these are, unless stated otherwise, measurement values, parameters or material properties which are measured at 25° C. and also preferably at standard pressure. Standard pressure is understood to mean a pressure of 101.3 kPa, preferably 101 325 Pa.

Where numerical ranges in the form “X to Y” are reported hereinafter, where X and Y represent the limits of the numerical range, this is synonymous with the statement “from at least X up to and including Y”, unless stated otherwise. Statements of ranges thus include the range limits X and Y, unless stated otherwise.

The expression “Cₓ-C_{y}” represents x to y carbon atoms. A Cₓ-C_{y}-alkyl radical is thus, for example, an alkyl radical having x to y carbon atoms; a Cₓ-C_{y}-alkoxy radical is analogously an alkoxy radical having x to y carbon atoms; a Cₓ-C_{y} alcohol is an alcohol having x to y carbon atoms, etc.

The repeat units in the formulae that follow may be distributed statistically. Statistical distributions are of blockwise construction with any desired number of blocks and with any desired sequence or are subject to a randomized distribution; they may also have an alternating construction or else form a gradient over the chain, where one is present; in particular they can also form all mixed forms in which groups with different distributions may optionally follow one another.

The composition according to the invention comprises at least one organosiloxane (A), at least one emulsifier (B) and water, wherein the organosiloxane (A) has SiC-bonded C₂-C₆-alkyl radicals and SiC-bonded C₇-C₁₈-alkyl radicals.

The composition according to the invention thus comprises water. Organic solvents are thus not required. This is advantageous since organic solvents can cause unpleasant odours, damage to health and the environment, and explosive vapours. Organic solvents are understood to mean volatile organic substances and mixtures thereof that have a boiling point of ≤200° C. (standard pressure), are liquid under standard conditions (20° C. and 101.3 kPa), and are used to dissolve or dilute other substances without altering them chemically. This corresponds to the definition in the Technical Rules for Hazardous Substances 610, issued by the German Federal Institute for Occupational Safety and Health (January 2011 edition). It is therefore preferable that the proportion by mass of organic solvents based on the total mass of composition is less than 15%, preferably less than 10%, especially less than 5%. It is particularly preferable that the composition is (essentially) free of organic solvents. It is particularly preferable that the proportion by mass of ethanol based on the total mass of composition is less than 15%, preferably less than 10%, especially less than 5%. It is particularly preferable that the composition is (essentially) free of ethanol. Suitable organic solvents are for example—but not exclusively—aliphatic and aromatic hydrocarbons having a boiling point above room temperature, such as C₆- to C₁₂-alkanes, petroleum, white spirit, diesel, kerosene, toluene, xylene, alcohols or polyols, such as pentanol, hexanol, octanol, nonanol, isononanol, glycerol, ethers, esters, aldehydes, ketones or a mixture of at least two of the aforementioned organic solvents. As already elucidated, however, preference is given to abstain from the usage of organic solvents.

The composition is preferably a dispersion. It is further preferable here that the dispersion medium comprises the predominant portion of the water present in the composition, and the disperse phase the predominant portion of the organosiloxanes present in the composition. It is alternatively possible, albeit less preferred, that the disperse phase comprises the predominant portion of the water present in the composition, and the dispersant the predominant portion of the organosiloxanes present in the composition.

The dispersion may, for example, be a suspension or an emulsion. The emulsion may, for example, be a water-in-oil emulsion (W/O emulsion) or an oil-in-water emulsion (O/W emulsion). It is preferable, however, that the composition is an emulsion, preferably an oil-in-water emulsion (O/W emulsion). It is further preferable that the predominant portion of the organosiloxanes present in the composition is present in the oil phase.

An organosiloxane is understood here to mean a compound having organic radicals bonded to silicon atoms and structural units of the formula ≡Si—O—Si≡, where “≡” represents the three remaining valences of the silicon atom in question. The organosiloxanes preferably contain or consist of units selected from the group consisting of M=[R₃SiO_{1/2}], D=[R₂SiO_{2/2}] and T=[RSiO_{3/2}] and optionally Q=[SiO_{4/2}], where R is a monovalent organic radical. The R radicals may also be partly replaced here by non-organic monovalent radicals, for example hydrogen atoms, hydroxyl groups or chlorine atoms. The R radicals may each be selected independently or one another and are the same or different when compared in pairs. Linear organosiloxanes are composed or two M units and optionally additional D units, but do not contain any T or Q units. In contrast, branched organosiloxanes, in addition to M units and optionally additional D units, mandatorily contain at least one T unit or Q unit. Cited as a reference in relation to the M, D, T, Q nomenclature used to describe the units of organosiloxanes is W. Noll, Chemie und Technologie der Silicone [Chemistry and Technology of the Silicones], Verlag Chemie GmbH, Weinheim (1960), page 2 ff.

The composition according to the invention contains at least one organosiloxane (A). The organosiloxane (A) has both SiC-bonded C₂-C₆-alkyl radicals and SiC-bonded C₇-C₁₈-alkyl radicals. A Cₓ-C_{y} alkyl radical here is understood to mean an alkyl radical having x to y carbon atoms. A C₂-C₆-alkyl radical is thus an alkyl radical having 2 to 6 carbon atoms, i.e. an alkyl radical having 2, 3, 4, 5 or 6 carbon atoms. A C₇-C₁₈-alkyl radical is in turn an alkyl radical having 7 to 18 carbon atoms, i.e. an alkyl radical having 7, 8, 9, 10, 11, 12, 13, 14, 15, 16, 17 or 18 carbon atoms. The alkyl radicals may each independently be linear, cyclic or branched. The alkyl radicals are preferably linear or branched, especially linear.

Said SiC-bonded C₂-C₆-alkyl radicals and said SiC-bonded C₇-C₁₈-alkyl radicals of the organosiloxane (A) consist exclusively of carbon atoms and hydrogen atoms. Said SiC-bonded C₂-C₆-alkyl radicals and said SiC-bonded C₇-C₁₈-alkyl radicals of the organosiloxane (A) thus do not contain any heteroatoms. A heteroatom is in this case an atom which is neither a carbon atom nor a hydrogen atom.

The composition according to the invention is therefore a composition comprising at least one organosiloxane (A), at least one emulsifier (B) and water, characterized in that the organosiloxane (A) has SiC-bonded C₂-C₆-alkyl radicals and SiC-bonded C₇-C₁₈-alkyl radicals which consist exclusively of carbon atoms and hydrogen atoms.

Synonymously, the composition according to the invention is therefore a composition comprising at least one organosiloxane (A), at least one emulsifier (B) and water, characterized in that the organosiloxane (A) has SiC-bonded C₂-C₆-alkyl radicals and SiC-bonded C₇-C₁₈-alkyl radicals which do not contain any heteroatoms.

Unless explicitly stated otherwise, in the context of the present disclosure, alkyl radicals are understood to mean only those alkyl radicals which do not include any heteroatoms. Unless explicitly stated otherwise, therefore, an alkyl radical having x carbon atoms, also referred to here as a Cₓ-alkyl radical, has 2·x+1 hydrogen atoms. By way of example, a C₃-alkyl radical (also referred to as propyl radical) consists of 3 carbon atoms and 7 hydrogen atoms; a C₈-alkyl radical (also referred to as octyl radical) in turn consists of 8 carbon atoms and 17 hydrogen atoms. The alkyl radicals here may be linear or branched. By way of example, “butyl” can thus represent n-butyl (also referred to as butan-1-yl), sec-butyl (also referred to as butan-2-yl or 1-methylpropyl), isobutyl (also referred to as 2-methylpropan-1-yl or 2-methylpropyl) and/or tert-butyl (also referred to as 2-methylpropan-2-yl or 1,1-dimethylethyl).

The SiC-bonded C₂-C₆-alkyl radicals are preferably C₂-C₆-alkyl radicals, especially propyl radicals. The C₂-C₆-alkyl radicals may be the same or different in pairs. Preferably, all C₂-C₆-alkyl radicals are identical.

The SiC-bonded C₇-C₁₈-alkyl radicals are preferably C₇-C₉-alkyl radicals, especially octyl radicals. The C₇-C₁₈-alkyl radicals may be the same or different in pairs. Preferably, all C₇-C₁₈-alkyl radicals are identical.

It Is thus preferable that the SiC-bonded C₂-C₆-alkyl radicals and SiC-bonded C₇-C₁₈-alkyl radicals are SiC-bonded C₂-C₅-alkyl radicals and SiC-bonded C₇-C₉-alkyl radicals. It is further preferable that the SiC-bonded C₂-C₆-alkyl radicals and SiC-bonded C₇-C₁₈-alkyl radicals are propyl radicals and octyl radicals. It is especially preferably here that the propyl radicals are n-propyl radicals and the octyl radicals are n-octyl radicals.

A SiC-bonded alkyl radical is understood to mean an alkyl radical bonded to a silicon atom via one of its carbon atoms. The SiC-bonded alkyl radical is thus part of the ≡Si-alkyl structural unit where “≡” represents the three remaining valences of the silicon atom in question. By contrast, alkoxy groups are, for example, SiOC-bonded alkyl radicals in which the alkyl radical is part of a ≡Si—O-alkyl structural unit.

It is preferable that the organosiloxane (A) in the composition according to the invention contains or consists of units of the formula

R¹Si(OR²)ₐO_{(3-a)/2} (I)
and preferably units of the formula

R³₂Si(OR²)_{b}O_{(2-b)/2} (II),
in which
R¹ is a C₂-C₆-alkyl radical or a C₇-C₁₈-alkyl radical, preferably a propyl radical or an octyl radical, with the proviso that the organosiloxane (A) contains, as R¹ radicals, both C₂-C₆-alkyl radicals and C₇-C₁₈-alkyl radicals, preferably both propyl radicals and octyl radicals;
R² is a C₁-C₄-alkyl radical, preferably ethyl radical, or a hydrogen atom or a radical of the formula —[YO]ₙZ where
   Y is a C₂-C₁₀-alkylene radical, preferably a C₂-C₅-alkylene radical,
   n is an integer from 1 to 10, preferably 1, and
   Z is a hydrogen atom or a bond to a silicon atom;
R³ is a C₁-C₄-alkyl radical, preferably a methyl radical;
a is 0, 1 or 2;
b is 0 or 1, preferably 0.

It is especially preferable here that, in the case of the R¹ radical, the propyl radical is an n-propyl radical and the octyl radical is an n-octyl radical. It is likewise preferable that R² is not a hydrogen atom.

It is preferable that a unit of the formula (I) that bears a C₂-C₆-alkyl radical is adjacent to at least one further unit that bears a C₂-C₆-alkyl radical. It is thus further preferable that a unit of the formula (I) that bears a propyl radical, especially n-propyl radical, is adjacent to at least one further unit that bears a propyl radical, especially n-propyl radical. The organosiloxane (A) thus preferably has blocks of units of the formula (I) that bear a C₂-C₆-alkyl radical, preferably propyl radical, especially n-propyl radicals. It is further preferable that these blocks comprise 2 to 20, preferably 2 to 10, further preferably 2 to 6, especially 2 to 4, silicon atoms. It is thus preferable that the organosiloxane (A) has blocks of 2 to 20, preferably 2 to 10, further preferably 2 to 6, especially 2 to 4, units of the formula (I) that bear a C₂-C₆-alkyl radical, preferably propyl radical, especially n-propyl radicals.
Z in the abovementioned formula —[YO]ₙZ is a hydrogen atom or a bond to a silicon atom. “Bond” is understood here to mean a covalent bond in the form or a single bond (σ bond). If Z is a bond to a silicon atom, Z is thus a covalent bond in the form of a single bond (σ bond). Z in the abovementioned Formula —[YO]ₙZ is thus a hydrogen atom or a single bond (σ bond) to a silicon atom.

It is advantageous that the organosiloxane (A), based on the total number of units of the formula (I) and (II), contains or consists of at least 50 mol %, preferably at least 60 mol %, especially at least 70 mol %, of units of the formula (I) and not more than 50 mol %, preferably not more than 40 mol %, especially not more than 30 mol %, of units of the formula (I).

It is also preferable that the viscosity of the organosiloxane (A) is from 1 to 100 mPa·s, preferably 10 to 50 mPa·s, especially from 20 to 40 mPa·s. The viscosity is preferably determined here according to standard DIN 53015 (publication date: June 2019), as described in the examples.

It is further preferable that the number-average molecular weight (Mn) of the organosiloxane (A) is from 500 to 2500 g/mol, preferably from 700 to 1800 g/mol, especially from 900 to 1200 g/mol. It is also preferable that the weight-average molecular weight (Mw) of the organosiloxane (A) is from 600 to 3000 g/mol, preferably from 800 to 2200 g/mol, especially from 1000 to 1500 g/mol. The number-average molecular weight (Mn) and the weight-average molecular weight (Mw) are preferably determined by GPC against a polystyrene standard, as described in the examples.

It is preferable that the organosiloxane (A) contains, in part by mass based on its total mass,
20% to 80%, preferably 30% to 70%, especially 40% to 60%, of SiC-bonded C₂-C₅-alkyl radicals and
30% to 40%, preferably 25% to 35%, especially 20% to 30%, of SiC-bonded C₇-C₁₈-alkyl radicals.

It Is further preferable that the mass ratio of all SiC-bonded C₂-C₈-alkyl radicals to all SiC-bonded C₇-C₁₈-alkyl radicals is from 5:1 to 1:5, preferably from 3:1 to 1:3, especially from 2:1 to 1:1.

It Is preferable to prepare the organosiloxane (A) by a process in which a reaction mixture composed of
i. at least one C₂-C₆-alkylalkoxysilane and/or at least one C₂-C₆-alkylalkoxysiloxane, preferably at least one C₂-C₆-alkylalkoxysiloxane, especially a propyltriethoxysilane oligomer mixture,
ii. at least one C₇-C₁₈-alkylalkoxysilane and/or at least one C₇-C₁₈-alkylalkoxysiloxane, preferably at least one C₇-C₁₈-alkylalkoxysilane, especially octyltriethoxysilane,
iii. water,
iv. preferably at least one mono- or polyfunctional C₂-C₁₀ alcohol,
v. preferably at least one cyclic dimethylsiloxane,
vi. preferably at least one tetraalkylammonium hydroxide, in particular tetrabutylammonium hydroxide,
vii. preferably at least one superacid, in particular trifluoromethanesulfonic acid,
viii. and optionally further substances is converted.

It Is further preferred to prepare the organosiloxane (A) according to a process in which a reaction mixture composed of
i. at least one C₂-C₆-alkylalkoxysilane and/or at least one C₂-C₆-alkylalkoxysiloxane, preferably at least one C₂—C-alkylalkoxysiloxane, especially a propyltriethoxysilane oligomer mixture,
ii. at least one C₇-C₁₈-alkylalkoxysilane and/or at least one C₇-C₁₈-alkylalkoxysiloxane, preferably at least one C₇-C₁₈-alkylalkoxysilane, especially octyltriethoxysilane,
ii. water,
iv. preferably at least one mono- or polyfunctional C₂-C₁₀ alcohol,
v. preferably at least one cyclic dimethylsiloxane,
vi. preferably tetrabutylammonium hydroxide,
vii. preferably trifluoromethanesulfonic acid,
viii. and optionally further substances
   is converted.

It is preferable here that the conversion of the aforementioned reactants to the organosiloxane (A) takes place in the presence of at least one tetraalkylammonium hydroxide and at least one superacid and reaction products thereof as catalyst.

It is thus preferred to prepare the organosiloxane (A) according to a process in which a reaction mixture composed of
i. at least one C₂-C₆-alkylalkoxysilane and/or at least one C₂-C₆-alkylalkoxysiloxane, preferably at least one C₂-C₆-alkylalkoxysiloxane, especially a propyltriethoxysilane oligomer mixture,
ii. at least one C₇-C₁₆-alkylalkoxysilane and/or at least one C₇-C₁₈-alkylalkoxysiloxane, preferably at least one C₇-C₁₈-alkylalkoxysilane, especially octyltriethoxysilane,
iii. water,
iv. preferably at least one mono- or polyfunctional C₂-C₁₀ alcohol,
v. preferably at least one cyclic dimethylsiloxane,
vi. at least one tetraalkylammonium hydroxide, preferably tetrabutylammonium hydroxide,
vii. at least one superacid, preferably trifluoromethanesulfonic acid.
vii. and optionally further substances
   is converted.

It Is particularly preferable here that the conversion of the aforementioned reactants to the organosiloxane (A) takes place in the presence of tetrabutylammonium hydroxide and trifluoromethanesulfonic acid and reaction products thereof as catalyst.

It is thus particularly preferred to prepare the organosiloxane (A) according to a process in which a reaction mixture composed of
i. at least one C₂-C₆-alkylalkoxysilane and/or at least one C₂-C₆-alkylalkoxysiloxane, preferably at least one C₂-C₆-alkylalkoxysiloxane, especially a propyltriethoxysilane oligomer mixture.
ii. at least one C₇-C₁₈-alkylalkoxysilane and/or at least one C₇-C₁₈-alkylalkoxysiloxane, preferably at least one C₇-C₁₈-alkylalkoxysilane, especially octyltriethoxysilane,
iii. water,
iv. preferably at least one mono- or polyfunctional C₂-C₁₀ alcohol,
v. preferably at least one cyclic dimethylsiloxane,
vi. tetrabutylammonium hydroxide,
vii. trifluoromethanesulfonic acid,
viii. and optionally further substances
   is converted.

The Invention therefore also further provides a process for preparing organosiloxanes (A), preferably for preparing the composition according to the invention, comprising a process step in which a reaction mixture composed of
i. at least one C₂-C₆-alkylalkoxysilane and/or at least one C₂-C₆-alkylalkoxysiloxane, preferably at least one C₂-C₆-alkylalkoxysiloxane, especially a propyltriethoxysilane oligomer mixture,
ii. at least one C₇-C₁₆-alkylalkoxysilane and/or at least one C₇-C₁₆-alkylalkoxysiloxane, preferably at least one C₇-C₁₆-alkylalkoxysilane, especially octyltriethoxysilane,
iii. water.
iv. preferably at least one mono- or polyfunctional C₂-C₁₀ alcohol,
v. preferably at least one cyclic dimethylsiloxane,
vi. at least one tetraalkylammonium hydroxide, preferably tetrabutylammonium hydroxide,
vii. at least one superacid, preferably trifluoromethanesulfonic acid,
viii. and optionally further substances
   is converted.

Accordingly preferred is a process for preparing organosiloxanes (A), preferably for preparing the composition according to the invention, comprising a process step in which a reaction mixture composed of
i. at least one C₂-C₆-alkylalkoxysilane and/or at least one C₂-C₆-alkylalkoxysiloxane, preferably at least one C₂-C₆-alkylalkoxysiloxane, especially a propyltriethoxysilane oligomer mixture,
ii. at least one C₇-C₁₈-alkylalkoxysilane and/or at least one C₇-C₁₈-alkylalkoxysiloxane, preferably at least one C₇-C₁₈-alkylalkoxysilane, especially octyltriethoxysilane,
iii. water,
iv. preferably at least one mono- or polyfunctional C₂-C₁₀ alcohol,
v. preferably at least one cyclic dimethylsiloxane,
vi. tetrabutylammonium hydroxide,
vii. trifluoromethanesulfonic acid,
viii. and optionally further substances
   is converted.

The reaction mixture is preparable by mixing the aforementioned components i. to viii.

The reaction mixture is preferably prepared from
100 parts by weight of component i.,
40 to 90, preferably 80 to 70, parts by weight of component ii.,
5 to 35, preferably 10 to 20, parts by weight of component iii.,
0 to 10, preferably 1 to 5, parts by weight of component iv.,
5 to 35, preferably 10 to 20, parts by weight of component v.,
1.0·10⁻⁴ to 1.0·10⁻², preferably 1.0·10⁻³ to 3.0·10⁻³, parts by weight of component vi.,
1·10⁻⁴ to 5·10⁻³, preferably 5·10⁻⁴ to 1.5·10⁻³, parts by weight of component vii., and
0 to 20, preferably 0 to 10, parts by weight of component viii.

The alkoxy groups of the aforementioned alkylalkoxysilanes and alkylalkoxysiloxanes are preferably C₁-C₄-alkoxy groups, i.e. alkoxy groups having 1 to 4 carbon atoms. These are thus preferably methoxy, ethoxy, propoxy and/or butoxy groups, but especially ethoxy groups. In the preparation of the organosiloxane (A), the alkoxy groups are partly or fully converted to the corresponding alcohols. Ethoxy groups have the advantage over methoxy, propoxy or butoxy groups that the ethanol formed in the reaction, by contrast with methanol, is non-toxic, and, by contrast with propanol and butanol, can be removed more easily on account of its lower boiling point.

Cₓ-C_{y}-alkylalkoxysilanes are understood here to mean those alkylalkoxysilanes having SiC-bonded alkyl radicals having x to y carbon atoms. The Cₓ-C_{y}-alkylalkoxysilanes are selected from the group consisting of Cₓ-C_{y}-alkyltrialkoxysilanes, Cₓ-C_{y}-dialkyldialkoxysilanes and Cₓ-C_{y}-trialkylalkoxysilanes, preferably from the group consisting of Cₓ-C_{y}-alkyltrialkoxysilanes and Cₓ-C_{y}-dialkyldialkoxysilanes, especially from the group consisting of the Cₓ-C_{y}-alkyltrialkoxysilanes.

Cₓ-C_{y}-alkylalkoxysiloxanes are understood here to mean those alkylalkoxysiloxanes having SiC-bonded alkyl radicals having x to y carbon atoms. These are oligomers or polymers, preferably oligomers having 2 to 20, preferably 2 to 10, further preferably 2 to 6, especially 2 to 4, silicon atoms. Preferred Cₓ-C_{y}-alkylalkoxysiloxanes are thus Cₓ-C_{y}-alkylalkoxysiloxanes having 2 to 20, preferably 2 to 10, further preferably 2 to 6, especially 2 to 4, silicon atoms. Cₓ-C_{y}-alkylalkoxysiloxanes may be preparable from Cₓ-C_{y}-alkylalkoxysilanes by a combined hydrolysis and condensation reaction (also referred to hereinafter as condensation for short). The alkoxy groups bonded to silicon (≡Si—OR) are reacted here with water, releasing alcohol (R—OH) to give silanol groups (≡Si—OH) (hydrolysis), and these are then converted in turn, releasing water to give siloxane groups (≡Si—O—Si≡) (condensation). The water released can then react again with further alkoxysilane groups and to such an extent that the water is ultimately fully consumed. Complete conversion can be achieved by distillatively removing the alcohol released. These processes for preparing alkylalkoxysiloxanes are known to those skilled in the art. They are described, for example, in EP 0 814 110 A1, EP 1 205 481 A2, EP 1 205 505 and EP 1 982 964 A1. The propylethoxysilane oligomers (especially propyltriethoxysilane oligomers) or propylethoxysilane oligomer mixtures (especially propyltriethoxysilane oligomer mixtures), i.e. oligomers or mixtures or oligomers prepared from propylethoxysilanes (especially propyltriethoxysilane), that are used with preference for preparation of the organosiloxane (A) as monomers are preferably prepared as described in EP 0 814 110 A1, EP 1 205 481 A2, EP 1 205 505 A2. Mixtures of alkylalkoxysiloxanes, especially propylethoxysilane oligomer mixtures, are commercially available, for example Protectosil® 266 from Evonik Operations GmbH.

Even more preferably used as component i. is at least one n-propylalkoxysiloxane and/or at least one i-propylalkoxysiloxane, and as component ii. at least one n-octylalkoxysilane and/or at least one i-octylalkoxysilane. Even more preferably used as component i. is at least one n-propylaloxysiloxane, and as component ii. n-octyltriethoxysilane.

Preferred components i are especially propylethoxysilane oligomer mixtures containing oligomers of the formula (III)

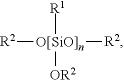

and R¹ is in each case independently an n-propyl radical or an i-propyl radical, preferably an n-propyl radical, R² is an ethyl radical, and the index n is from 2 to 20, preferably from 2 to 10, further preferably 2 to 6, especially from 2 to 4. The index n here represents the degree of oligomerization.

Components iv. used in the reaction mixture are mono- or polyfunctional C₂-C₁₀ alcohol, preferably difunctional C₂-C₁₀ alcohols. Examples are ethylene glycol (ethanediol), propylene glycols (propanediols), butylene glycols (butanediols) and pentylene glycols (pentanediols).

Components v. used in the reaction mixture are cyclic dimethylsiloxanes, preferably octamethylcyclotetrasiloxane (D4), decamethylcyclopentasiloxane (D5) or any mixtures of these available on an industrial scale.

Component vi. used in the reaction mixture is at least one tetraalkylammonium hydroxide. It is preferable here for the alkyl radicals of the tetraalkylammonium hydroxide to be selected from C₁-C₁₀-alkyl radicals. These alkyl radicals may be the same or different in this case, but are preferably the same. These alkyl radicals may also be linear or branched, but are preferably linear. A particularly preferred tetraalkylammonium hydroxide is tetrabutylammonium hydroxide, where butyl is n-butyl.

Component vii. used in the reaction mixture is preferably at least one superacid, especially trifluoromethanesulfonic acid.

The organosiloxanes (A) can be prepared from the aforementioned alkylalkoxysilanes and/or alkylalkoxysiloxanes and water via a hydrolysis and condensation reaction, releasing alcohol. The hydrolysis and condensation reaction is effected as described above. The alkoxy groups bonded to silicon (≡Si—OR) are reacted here with water, releasing alcohol (R—OH) to give silanol groups (≡Si—OH) (hydrolysis), and these are then converted in turn, releasing water to give siloxane groups (≡Si—O—Si≡) (condensation). The water released can subsequently react again with alkoxysilane groups etc., until the water has been fully consumed. However, a reaction of the alcohol released with silanol groups to form water is also possible. Full conversion can therefore be achieved, for example, by removing the alcohol released by distillation. Any mono- or polyfunctional C₂-C₁₀ alcohols used can likewise react with silanol groups. In parallel to the hydrolysis and condensation reaction, equilibration of the cyclic dimethylsiloxanes also takes place, in which the cycles are ring-opened and react (“equilibrate”) with the siloxane groups (≡Si—O—Si≡) present in the reaction system and form longer siloxane chains. The reaction is preferably conducted until equilibrium has been established.

The reaction preferably takes place in the presence of catalysts. Suitable acidic catalysts are the strong acids (equilibrating acids) known from the prior art for siloxanes, i.e. mineral acids, for example sulfuric acid, but also sulfonic acids and perfluoroalkanesulfonic acids, acidic aluminas or acidic ion exchange resins, for example the products known by the Amberlite®, Amberlyst@ or Dowex® and Lewatit® brand names. Preference is given here to superacids. Superacids refer to acids which are stronger than concentrated (100 percent) sulfuric acid (H₂SO₄: pKa=−3.0). Examples of superacids are, without being limited thereto, perchloric acid (HClO₄), fluorosulfonic acid (HSO₃F), fluoroantimonic acid (HSbF₈), “magic” acid (a mixture of fluorosulfonic acid and antimony(V) fluoride (SbF₅)) and trifluoromethanesulfonic acid. Particular preference is given here to trifluoromethanesulfonic acid. Examples of suitable catalysts are especially trifluoromethanesulfonic acid, methanesulfonic acid, p-toluenesulfonic acid and trifluoroacetic acid. Particular preference is given to trifluoromethanesulfonic acid. Examples of suitable catalysts may thus also include acids which are not superacids. Detailed compilations of the pKa values of Brønsted acids can be found in the literature and can be inferred therefrom, for example CRC Handbook of Chemistry and Physics 99th edition. The pKa can also be determined by the available methods known to the person skilled in the art. Aside from possibly anomalously referenced pKa values, potentiometric titration is found to be a particularly suitable method for exact determination of pKa values for the purposes of the present invention. This method is long-established; cf., for example, Benet L. Z., Goyan J. E.: Potentiometric determination of dissociation constants; J. Pharm. Sci. 56, 665-680 (1967).

It is a feature of the process according to the invention for preparing organosiloxanes (A) that it is conducted in one stage. This involves initial charging of alkoxyalkylsilanes (also referred to as alkylalkoxysilanes) and/or alkoxyalkyisiloxanes (also referred to as alkylalkoxysloxanes), water and preferably organic mono- and diols and/or preferably cyclic dimethylsiloxanes. In the process according to the invention, not only the acidic catalyst (trifluoromethanesulfonic acid) but also a basic catalyst (tetrabutylammonium hydroxide) is used. Both catalysts are established catalysts for the equilibration of polysiloxanes, and they also catalytically promote condensation. The basic catalyst promotes alcoholysis, while the acidic catalyst preferentially catalyses condensation. Equilibration and condensation thus proceed simultaneously. It is especially advantageous here that tetrabutylammonium hydroxide and trifluoromethanesulfonic acid are used in a mass ratio of 1.5:1 to 3:1.

It is further preferable that the preparation of the organosiloxane (A) from the reaction mixture is conducted at a temperature of 40° C. to 150° C., preferably of 70° C. to 120° C. over a period of one to 8 hours, preferably over a period of 3 to 6 hours. The reaction is preferably conducted at a pressure of 1 mbar to 1013 mbar.

It is also preferable to remove volatile constituents from the reaction product thereafter at 80° C. to 120° C., preferably 90° C. to 110° C., at standard pressure or reduced pressure until essentially no further distillate is obtained.

It is further preferable to remove any acids still present in the reaction product. It is therefore preferable that any acids present in the reaction product are neutralized at a temperature of 20° C. to 110° C., preferably 40° C. to 80° C., by adding a solid, liquid or gaseous base, preference being given to the use of a solid base, especially in the form of carbonates and/or hydrogencarbonates of the alkali metal and/or alkaline earth metal elements and/or or ammonium or the use of liquid bases. In this case preferably of aliphatic and/or aromatic and/or alkylaromatic amines, or the use of ammonia as gaseous base. Particular preference is given to ammonia. The amount of the solid, liquid or gaseous base added is preferably guided by the amount of acid(s) present in the reaction mixture. Preference is given to using the base in stoichiometric amounts. Excessively large excesses of base are disadvantageous especially for a preparation process conducted on an industrial scale, since the associated salt burden increases the filtration complexity involved. Large amounts of liquid organic bases (amines) can likewise be disruptive, since these can remain in the product. Aromatic amines can be hazardous to health and have an adverse effect on product properties.

The reaction product obtained may still comprise volatile reaction products and/or by-products and/or reactants. It is advantageous to substantially remove these. It is therefore preferable to remove these volatile constituents from the reaction product, or reduce the proportion thereof, over a duration of 1 to 8 hours, preferably 1 to 4 hours, at a temperature of 80° C. to 140° C., preferably 100° C. to 130° C., with application of an auxiliary vacuum of less than 200 mbar, preferably less than 20 mbar, especially of less than 10 mbar.

In order to purify the reaction product, filtration can optionally be carried out. Filter aids used in this case may be, for example, cellulose, silica gel, kieselguhr or perlite. The proportion of undesirable substances or impurities in the reaction product can also be reduced by means of activated carbon and/or bleaching earths, for example Tonsil.

The composition according to the invention comprises, as well as the above-described organosiloxanes (A), at least one emulsifier (B). The emulsifier may be selected from cationic, anionic, amphoteric (for example ampholytes and betaines) and nonionic emulsifiers. The emulsifiers (B) are different from the organosiloxanes (A) and, if they are likewise present in the composition, from the organosiloxanes (C).

The composition according to the invention preferably comprises an emulsifier system composed of two or more emulsifiers (B).

Suitable emulsifiers and emulsifier systems are familiar to the person skilled in the art. Suitable emulsifiers or emulsifier systems are selected by way of example from alkyl sulfates having C₆-C₁₈-alkyl, alkyl and alkaryl ether sulfates having C₈-C₁₈-alkyl in the hydrophobic radical and having 1 to 40 ethylene oxide (EO) or propylene oxide (PO) units, alkylsulfonates having C₈-C₁₈-alkyl, sodium laurylsulfate (C₁₂-C₁₆), alkarylsulfonates having C₈-C₁₈-alkyl, monoesters of sulfosuccinic acid with monohydric alcohols or alkylphenols having 5 to 15 carbon atoms, alkali metal and ammonium salts of carboxylic acids having 8 to 20 carbon atoms in the alkyl, aryl, alkaryl or aralkyl radical, alkyl and alkaryl phosphates having 8 to 20 carbon atoms in the organic radical, alkyl ether or alkaryl ether phosphates having 8 to 20 carbon atoms in the alkyl or alkaryl radical and 1 to 40 EO units, alkyl polyglycol ethers and alkaryl polyglycol ethers having 8 to 40 EO units and 8 to 20 carbon atoms in the alkyl or alkaryl radicals, ethylene oxide/propylene oxide (EO/PO) block copolymer having 8 to 40 EO or PO units, addition products of alkylamines having C₈-C₂₂-alkyl radicals with ethylene oxide or propylene oxide, alkyl polyglycosides having linear or branched, saturated or unsaturated C₈-C₂₄-alkyl radicals and oligoglycoside radicals having 1 to 10 hexose or pentose units, silicon-functional surfactants or mixtures of these emulsifiers. Examples of silicon-containing surfactants are those of the general formulae

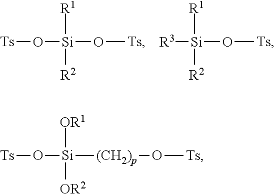

in which R¹ and R² are the same or different and are linear or branched C₁-C₂₀-alkyl, preferably C₁-C₁₀-alkyl, phenyl, R³ is C₁-C₁₀-alkyl, p is an integer from 0 to 3 and Ts is a surfactant radical selected from

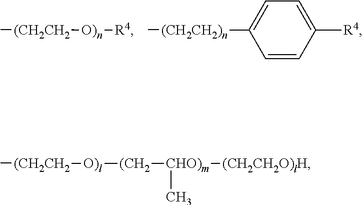

in which n is an integer from 3 to 15, m is an integer from 3 to 50 and l is an integer from 3 to 25, R⁴ is H, C₁-C₂₀-alkyl, C₂-C₃₆-alkenyl, C₅-C₆-cycloalkyl, C₇-C₃₆-aralkyl.

A suitable example is a combination of alkyl sulfates having C₆-C₁₈-alkyl radicals, for example of lauryl sulfates, and silicon-functional surfactants of the formula

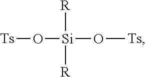

in which R is methyl, ethyl, methoxy or ethoxy, and the surfactant radical is

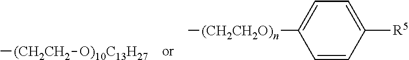

where, in the formula, n is an integer from 5 to 15 and R⁵ is a linear or branched C₆-C₁₀-alkyl radical. A particularly suitable surfactant is one of the above formulae in which R═CH₃, n=1 to 30 and R⁵=isononyl.

However, the emulsifiers (B) used are preferably not silicon compounds. The emulsifiers (B) thus preferably do not have any silicon atoms.

It is further preferable that the emulsifier (B) Is a nonionic emulsifier, preferably an alkoxylated alcohol or an alkoxylated carboxylic acid, especially an alkoxylated alcohol. It is especially preferable that two or more emulsifiers (B) are used, especially two or more alkoxylated alcohols.

The emulsifier (B) is preferably a compound of the formula (IV)

R⁴O—[(C₂H₃R⁵)—O]ₙ—H Formula (IV)
where
R⁴ is a monovalent aliphatic radical having 4 to 30, preferably 8 to 20, especially 11 to 15, carbon atoms;
R⁵ is in each case independently a hydrogen atom or a C₁-C₆-alkyl radical, preferably a hydrogen atom or methyl radical, especially a hydrogen atom;
n is a number from 1 to 300, preferably from 2 to 100, especially from 3 to 40.

The compound of the formula (IV) is thus an alkoxylated alcohol.

The emulsifier (B) Is likewise preferably a compound of the formula (V)

R⁴(CO)O—[(C₂H₃R⁵)—O]ₙ—H Formula (V)
where
R⁴ is a monovalent aliphatic radical having 4 to 30, preferably 8 to 20, especially 11 to 15, carbon atoms;
R⁵ is in each case independently a hydrogen atom or a C₁-C₆-alkyl radical, preferably a hydrogen atom or methyl radical, especially a hydrogen atom;
n is a number from 1 to 300, preferably from 2 to 100, especially from 3 to 40.

The compound of the formula (V) Is thus an alkoxylated carboxylic acid.

The compound of the formula (IV) or (V) has one or more divalent —[(C₂H₃R⁵)—O]— groups. The divalent —[(C₂H₃R⁵)—O]— groups are alkyleneoxy groups. If R⁵ is a hydrogen atom, i.e. R⁵═H, the —[(C₂H₃R⁵)—O]— group is a —[(C₂H₄)—O]— group, i.e. a —(CH₂—CH₂—O)— group, i.e. an ethyleneoxy group. If R⁵ is a C₁-C₄-alkyl radical, the alkyleneoxy group may in each case independently be in the spatial orientations —(CH₂—CH(R⁵)—O)— or —(CH(R⁵)—CH₂—O)—, but preferably in the spatial orientation —(CH₂—CH(R⁵)—O)—, in the compound of the formula (IV) or (V), where the compound of the formula (IV) or (V) should be based on the spatial orientation chosen in formula (IV) or (V), i.e. a spatial orientation in which the R⁴O group is present bonded at the left-hand end and the OH group at the right-hand end of the compound or the formula (IV) or (V).

R⁴ may, for example, be linear or branched, cyclic or acyclic, and saturated or unsaturated. R⁴ may be derived from a primary, secondary or tertiary alcohol. But R⁴ is preferably derived from a secondary alcohol.

The hydrophilicity/hydrophobicity of the emulsifier (B), preferably of the compound of the formula (IV) or (V), can be controlled, especially in order to obtain a particularly storage-stable and dilution-stable composition. In the case of compounds of the formula (IV) or (V), this can be achieved via the choice of R⁴ and R⁵ radicals and the index n, the degree or alkoxylation. It is preferable that the HLB value of the emulsifier (B), preferably or the compound of the formula (IV) or (V), is from 5 to 20, preferably from 8 to 18, especially from 10 to 16. “HLB” stands for hydrophilic-lipophilic balance. The HLB value can be determined by various prior art methods and is a recognized measure of hydrophobicity/hydrophilicity. The HLB value is preferably determined by the Griffin method (W. C. Griffin: Classification of surface active agents by HLB, J. Soc. Cosmet. Chem. 1, 1949, p. 311-326). The HLB value is calculated here by the formula

$$HLB = 20 \cdot ( 1 - \frac{{m}_{1}}{m} )$$

where m₁ is the molar mass of the lipophilic component of a molecule and m is the molar mass of the entire molecule. The molar mass mA of the hydrophilic component or a molecule is correspondingly round using mₕ=m−mᵢ. The molar masses are determined by prior art methods; they are preferably determined by mass spectrometry; the lipophilic component or the hydrophilic component is likewise preferably determined from the mass spectrometry results using the stoichiometric principles known to the person skilled in the art. The molar masses can also be calculated from the molecular structure. In the case of compounds of the formula (IV) or (V), mass of the hydrophilic component is calculated on the total mass of all —[(C₂H₃R⁵)—O]— with R⁵═H, i.e. from the total mass of all ethyleneoxy groups (oxyethylene groups) present.

Processes for preparing compounds of the formula (IV) or (V) are known to the person skilled in the art. The compounds of the formula (IV) or (V) are preferably obtained by reacting hydroxy-functional compounds of the formula R⁴—OH (i.e. an alcohol), where R⁴ is as defined in formula (IV), or R⁴—(CO)—OH (i.e. a carboxylic acid), where R⁴ is as defined in formula (V), with C₂-C₈-alkylene oxides, i.e. alkylene oxides having 2 to 8 carbon atoms. This reaction is an alkoxylation reaction of R⁴—OH or R⁴—(CO)—OH with C₂-C₈-alkylene oxides.

Preferred emulsifiers (B) are ethoxylated alcohols that are obtained by reacting one or more secondary C₄-C₂₂ alcohols having 4 to 22 carbon atoms with ethylene oxide (EO) in a molar ratio of 1:10 to 1:20. A Cₓ-C_{y} alcohol here is understood to mean an alcohol having x to y carbon atoms. Particular preference is given to an emulsifier mixture of at least one ethoxylated secondary C₁₁-C₁₅ alcohol having an average of 15 EO units and at least one ethoxylated secondary C₁₁-C₁₅ alcohol having an average of 5 EO units.

Emulsifiers (B), especially those of the formula (IV), are commercially available, for example TERGITOL™ 15-S-3, TERGITOL™ 15-S-5, TERGITOL™ 15-S-7 TERGITOL™ 15-S-9 TERGITOL™ 15-S-12, TERGITOL™ 15-S-15 TERGITOL™ 15-S-20 TERGITOL™ 15-S-30 TERGITOL™ 15-S-40 from The Dow Chemical Company.

It is preferable that the composition according to the invention comprises at least one organosiloxane (C) other than the organosiloxane (A), preferably an α,ω-dihydroxypolydimethylsiloxane and/or an α,ω-dimethylpolydimethylsiloxane and/or a polyether-polysiloxane copolymer (e.g. polyether-polydimethylsiloxane copolymer). The organosiloxane (C) additionally differs from the emulsifier (B). α,ω-Dihydroxypolydimethylsiloxanes and α,ω-dimethylpolydimethylsiloxanes and polyether-polysiloxane copolymers (e.g. polyether-polydimethylsiloxane copolymers) are known to the person skilled in the art. They improve the hydrophobization and beading effect of construction materials. The α,ω-dimethylpolydimethylsiloxanes and α,ω-dihydroxypolydimethylsiloxanes are preferably silicone oils. Suitable silicone oils or polyether-polysiloxane copolymers (polyether-polydimethylsiloxane copolymers) are commercially available, for example XIAMETER™ PMX-200 Silicone Fluid 1000 cSt (DOW SILICONES DEUTSCHLAND GMBH) or TEGOPREN® 3110 (Evonik Operations GmbH). Organosiloxanes (C) do not include organosiloxanes that are used as emulsifiers (B).

It is also preferable that the composition according to the invention comprises at least one additive (D).

The composition may comprise, for example, without limitation thereto, additives (D) (auxiliaries) selected from inorganic or organic acids, fatty acids, bases, buffer substances, fungicides, bactericides, algicides, microbiocides, odourants, corrosion inhibitors, preservatives, rheology aids, for example fumed silica or bentonites, drip-off aids, for example waxes, fluoropolymers, hydrophobic fumed silicas, those based on reactive organosiloxanes, silicone resins, trisiloxanes (e.g. TEGOPREN® 5840), catalysts, for example organic tin, titanium or zirconium compounds such as dibutyltin dilaurate, titanium alkoxides or zirconium alkoxides (e.g. tetrabutyl titanate).

The additives (D) may more preferably be pH regulators (buffers), i.e. compounds that serve to adjust and/or buffer the pH of the composition, for example NaHCO₃. These pH regulators may be protonated and/or deprotonated.

The desired pH can thus be established by addition of acid or alkaline compounds or by means of common buffer systems, such as NaHCO₃, sodium acetate/acetic acid or alkali metal phosphates, and can be determined by means or standard methods as known to the person skilled in the art, for example by means of pH paper or pH strips (from Merck) or a pH electrode. For instance, an emulsion used in accordance with the invention preferably has a pH of 8 to 12.

The additives (D) may also more preferably be preservatives (biocides). Examples of suitable preservatives include benzisothiazolinone (BIT), chloromethylisothiazolinone (CIT) and methylisothiazolinone (MIT), octylisothiazolinone (OIT), zinc pyrithione. Suitable preservatives are available, for example, under the ACTICIDE® name (Thor GmbH). The following are particularly suitable: ACTICIDE® MV (Thor GmbH), ACTICIDE® 20 (Thor GmbH) and ACTICIDE® MBS (Thor GmbH), ACTICIDE® BW20 (Thor GmbH), ACTICIDE® M 20 (Thor GmbH), ACTICIDE® ICB 5 (Thor GmbH).

The composition according to the invention thus comprises organosiloxanes (A) and emulsifiers (B), and optionally organosiloxanes (C) and optionally additives (D). Organosiloxanes (A), emulsifiers (B), organosiloxanes (C), additives (D) are all different from one another. If a compound can in principle be assigned to two or more of the aforementioned groups (A), (B), (C) and (D), this compound should be assigned to that group among those possible which is named first in the above sequence, unless this rule is explicitly departed from. If a compound, for example, can be assigned to any of groups (B), (C) and (D), it should be assigned to the first of the possible groups, i.e. (B) in this example. A compound is thus not assigned to more than one of groups (A), (B), (C) and (D). In order to avoid misunderstandings, it should additionally be made clear that the water likewise present in the composition according to the invention Is of course not assigned to any of the aforementioned groups (A), (B), (C) and (D). Water is thus especially not considered as additive (D) either.

It is preferable that the composition according to the invention, based in each case on the total mass of the composition, comprises the following constituents:
one or more organosiloxanes (A) in a proportion by mass of 10% to 80%, preferably of 20% to 70%, especially of 40% to 60%,
one or more emulsifiers (B) in a total proportion by mass of 1.5% to 15%, preferably of 2% to 10%, especially of 3% to 6%,
one or more organosiloxanes (C) in a proportion by mass of 0% to 30%, preferably of 0% to 20%, especially of 0% to 10%.
one or more additives (D) in a proportion by mass of 0% to 25%, preferably of 0% to 15%, especially of 0% to 10%, and
water in such a proportion by mass that the sum total of the proportions by mass of all constituents is 100%.

The composition may comprise further constituents as well as constituents (A) to (D), for example impurities. “The sum total of the proportions by mass of all constituents” is therefore understood to mean the sum total of the proportions by mass of constituents (A) to (D) and the further constituents not enumerated above.

The composition according to the invention, preferably the emulsion, especially the oil-in-water emulsion, can be produced via various methods. These methods are known to the person skilled in the art. The production can be effected, for example, but not exclusively, by premixing the constituents and then emulsifying, as described, for example, in WO 2006/081891 A1, WO 2006/081892 A1, WO 2008/128819 A1 and EP 0 538 555 A1.

For the formulation of a composition according to the invention, the following production methods in particular are used:
paste methods, in which organosilicon compounds are introduced into a concentrated composition composed of emulsifiers and water with input of high shear energy, and diluted further with water thereafter;
homogenization methods, in which organosilicon compounds, emulsifiers, water and additives, for example pH regulators (buffers) and preservatives (biocides) are emulsified and stabilized with input of high shear energy by homogenization tools (for example edge-gap homogenizer, capillary homogenizer, rotor-stator homogenizer, rotor-rotor homogenizer, ultrasound treatment):
inversion methods, in which the organosilicon compounds are initially charged, emulsifiers are added and the system is diluted and stabilized with water via an inverting water-in-oil phase to give an oil-in-water formulation;
continuous production methods, in which a modification of the paste method or of the homogenizer method is employed in a continuous process.

The compositions according to the invention show high dilution stability.

The invention therefore further provides for the use of the composition according to the invention as dilution-stable hydrophobizing agent.

If the composition does not show any separation on dilution with water to a water content of at least 95% after 12 weeks, it is considered to be dilution-stable. The water content is understood to mean the proportion by mass of water based on the total mass of the diluted composition (also called “dilution”).

Preference is given to using the composition according to the invention as dilution-stable composition for hydrophobizing impregnation and/or for bulk hydrophobization, more preferably for bulk hydrophobization.

The compositions according to the invention are especially suitable for hydrophobizing impregnation and bulk hydrophobization of mineral construction materials (e.g. cement, concrete, mortar, screed) and organic construction materials (e.g. wood), especially with the aim or building protection. However, the compositions according to the invention are particularly suitable in this case for bulk hydrophobization of mineral construction materials. It is particularly advantageous to use the composition according to the invention for the production of hydraulically setting compositions, in particular hydraulically setting mineral construction materials. The compositions according to the invention are therefore particularly preferably suitable for bulk hydrophobization of mineral construction materials (e.g. concrete, mortar, screed). They are therefore particularly preferably suitable for the production of hydraulically setting compositions. It is therefore also particularly preferred to use the composition according to the invention as dilution-stable composition for bulk hydrophobization of hydraulically setting compositions, in particular hydraulically setting mineral compositions.

A hydraulically setting composition is understood to mean a composition that cures in the presence of or in the case of addition of (additional) water (added water, makeup water). The total amount of water in the composition is the sum total of the amount of added water and the amount of water present in the composition according to the invention, especially the emulsion. A reaction of the water with the hydraulic binder is responsible for the curing. The building of a crystal structure typically takes place here with intercalation of the water as water of crystallization. Examples of hydraulic binders are cement or burnt gypsum. The preferred hydraulic binder is cement. The hydraulically setting composition is preferably a hydraulically setting cement mixture, especially mortar, screed or concrete. These cement mixtures, as well as the cement binder, also contain admixtures, for example sand, gravel, limestone or chalk, with different maximum particle size and particle size distribution.

In general, hydraulically setting cement mixtures are referred to as mortar when the maximum particle size of the aggregates is below 4 mm, as screeds when it is up to 8 mm, and as concretes when it is greater than 8 mm. Regardless of this, cement mixtures that are hydraulically setting in this respect, with regard to their application, contain water and may also contain further additives, admixtures and/or further mineral additions having hydraulic effects, for example—but not exclusively—pozzolans or fly ash, for specific applications.

The invention therefore further provides a hydraulically setting composition comprising the following components:
a) at least one hydraulic binder, preferably cement,
b) at least one composition according to the invention.
c) preferably at least one admixture selected from the group consisting of sand, gravel, limestone and chalk,
d) preferably additional water.

It is preferable here that the hydraulically setting composition contains
100 parts by weight of component a),
0.1 to 10, preferably 0.2 to 2, parts by weight of component b),
100 to 600, preferably 200 to 400, parts by weight of component c), and
20 to 100, preferably 30 to 70, parts by weight of component d).

Particular preference is given to using the composition or emulsion according to the invention in hydraulically setting cement mixtures by, during the production of an applicable mortar, screed or cement in a mixer, adding the composition or emulsion according to the invention in one dose or in portions and incorporating it substantially homogeneously by mixing; alternatively, the emulsion can be initially charged or added together with the added water.

It is particularly advantageous to use the composition or emulsion according to the invention as an addition in hydraulically setting cement mixtures, especially in concrete, porous concrete, underwater concrete, reinforced concrete, textile concrete or textile fibre concrete, screed, mortar, 2-component mortar, concrete repair mortar—to name just a few examples. In the case of a 2-component mortar, the second component is added in liquid form to the first component (generally a dry mortar mixture) directly prior to application. This second component may comprise, for example, polymer latex emulsions known to those skilled in the art for increasing the elasticity of the hydraulically setting cement mixture.

The examples that follow describe the present invention by way of example, without any intention that the invention, the scope of application of which is apparent from the entirety of the description and the claims, be restricted to the embodiments specified in the examples.

### EXAMPLES

General Methods:

Nuclear Magnetic Resonance Spectroscopy (NMR Spectroscopy):

The organosiloxanes can be characterized with the aid of ¹H NMR and ²⁹Si NMR spectroscopy. These methods, especially taking account of the multiplicity of the couplings, are familiar to the person skilled in the art.

Gel Permeation Chromatography (GPC):

GPC measurements for determination of the number-average and weight-average molar masses Mw are conducted under the following measurement conditions: Column combination SDV 1000/10 000 Å (length 55 cm), temperature 35° C., THF as mobile phase, flow rate 0.35 ml/min, sample concentration 10 g/l, RI detector, evaluation of the polymers against polystyrene standard (162-2 520 000 g/mol).

Viscosity:

Viscosity is determined according to standard DIN 53015 (date or issue: June 2019).

Raw Materials:

| Designation | Source | Characterization |
|---|---|---|
| Dynasylan ® | Evonik | n-Octyltriethoxysilane |
| OCTEO | Operations GmbH | |
| Protectosil ® 266 | Evonik | n-Propylethoxysiloxane (n- |
| | Operations GmbH | propyltriethoxysilane oligomer |
| | | mixture) |
| D5 | Dow Silicone | Decamethylcyclopentasiloxane |
| | Deutschland | |
| | GmbH | |
| Silicone oil 1000: | Dow Silicone | α,ω-Dimethylpolydimethyl- |
| XIAMETER ™ | Deutschland | siloxane |
| PMX-200 Silicone | GmbH | |
| Fluid 1000 cSt | | |
| TEGOPREN ® | Evonik | Trisiloxane |
| 5840 | Operations GmbH | |
| TEGOPREN ® | Evonik | Polyether-polysiloxane |
| 3110 | Operations GmbH | copolymer |
| MTES-HARZ 200 | Evonik | Methylsilicone resin |
| | Operations GmbH | |
| ACTICIDE ® B 20 | Thor GmbH | Biocide (preservative) |
| ACTICIDE ® MV | Thor GmbH | Biocide (preservative) |
| ACTICIDE ® MBS | Thor GmbH | Biocide (preservative) |
| Emulsifier 1: | The Dow | Ethoxylated secondary C₁₁-C₁₅ |
| TERGITOL ™ | Chemical | alcohol having an average of |
| 15-S-5 Surfactant | Company | 5 EO units |
| Emulsifier 2: | The Dow | Ethoxylated secondary C₁₁-C₁₅ |
| TERGITOL ™ | Chemical | alcohol having 15 EO units |
| 15-S-15 Surfactant | Company | |
| TEGOSIVIN ® | Evonik | Silane/siloxane-based |
| HE 328 | Operations GmbH | hydrophobizing agent |
| TEGOSIVIN ® | Evonik | Silane-based hydrophobizing |
| CA 880 | Operations GmbH | agent |

Compositions:

### Example 1

a) Organosiloxane:

At room temperature, a glass flask is initially charged with 1476.2 g of Protectosil® 268, 989.25 g of Dynasylan® OCTEO, 38.42 g of water, 161.71 g of D5 and 38.42 g of propylene glycol. At room temperature, 3.13 g of tetrabutylammonium hydroxide (40% in water) and 1.57 g of trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 60° C. and 125.16 g of silicone oil 1000 is added and stirred in for 30 min. After filtration, a colourless clear product having a viscosity of 34 mPa·s is obtained.

b) Bulk Hydrophobizing Agent (BHA):

A Jacketed temperature-controlled 2 l stirred glass vessel is initially charged with 32.5 g of demineralized water, 15.0 g of emulsifier 1, 7.5 g of emulsifier 2, 0.2 g of NaHCO₃ and 0.5 g ACTICIDE® B 20 and mixed together with a toothed disc (Ø=80 mm) at 1000 rpm at room temperature at 400 mbar for five minutes. In order to counteract any rise in temperature of the formulation, the glass vessel is cooled and the temperature of the contents is kept within a temperature range of 15-30° C. The stirrer speed is increased to 2000 rpm, and 250.0 g of the product described in a) is added dropwise and incorporated at 400 mbar over a period of 15 min. On completion of addition, stirring is continued at 15-30° C. at 2000 rpm at 400 mbar for 15 min. This is Followed by dropwise addition of 193.9 g of demineralized water at 400 mbar within 10 min. In the course of this, the stirrer speed is reduced gradually to 1000 rpm. 0.5 g or ACTICIDE® MV is added, and the mixture is stirred at 1000 rpm at 400 mbar for a further 10 min. Thereafter, the formulation is dispensed.

### Example 2

a) Organosiloxane:

At room temperature, a glass flask is initially charged with 1570.24 g of Protectosil® 266, 1052.27 g of Dynasylan® OCTEO, 38.74 g of water and 38.74 g of propylene glycol. At room temperature, 3.13 g of tetrabutylammonium hydroxide (40% in water) and 1.57 g of trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 60° C. and 126.33 g of silicone oil 1000 is added and stirred in for 30 min. After filtration, a colourless clear product having a viscosity of 32 mPa·s is obtained.

b) Bulk Hydrophobizing Agent (BHA):

A jacketed temperature-controlled 2 l stirred glass vessel is initially charged with 32.5 g of demineralized water, 15.0 g of emulsifier 1, 7.5 g of emulsifier 2, 0.2 g of NaHCO₃ and 0.5 g ACTICIDE® B 20, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a) is added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 0.5 g of ACTICIDE® MV is added, and the mixture is stirred at 1000 rpm at 400 mbar for a further 10 min. Thereafter, the formulation is dispensed.

### Example 3

a) Organosiloxane:

At room temperature, a glass flask is initially charged with 2694.4 g of Protectosil® 268, 1805.6 g of Dynasylan® OCTEO, 66.47 g of water, 295.15 g of D5 and 68.47 g of propylene glycol. At room temperature, 5.72 g of tetrabutylammonium hydroxide (40% in water) and 2.86 g of trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 60° C. After the filtration, a colourless clear product having a viscosity of 30 mPa·s is obtained.

b) Bulk Hydrophobizing Agent (BHA):

A jacketed temperature-controlled 2 l stirred glass vessel is initially charged with 32.5 g of demineralized water, 15.0 g of emulsifier 1, 7.5 g of emulsifier 2 and 0.2 g of NaHCO₃, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a), 0.5 g or TEGOPREN® 5840 and 5.0 g of TEGOPREN® 3110 are added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 1.0 g of ACTICIDE® MBS is added, and the mixture is stirred at 1000 rpm at 400 mbar for a further 10 min. Thereafter, the formulation is dispensed.

### Example 4

a) Organosiloxane:

At room temperature, a glass flask is initially charged with 1317.26 g of Protectosil® 266, 882.74 g of Dynasylan® OCTEO, 32.50 g of water and 144.30 g of D5. At room temperature, 2.76 g of tetrabutylammonium hydroxide (40% in water) and 1.38 g of trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 80° C. After filtration, a colourless clear product having a viscosity of 20 mPa·s is obtained.

b) Bulk Hydrophobizing Agent:

A jacketed temperature-controlled 2 l stirred glass vessel is initially charged with 32.5 g of demineralized water, 15.0 g of emulsifier 1, 7.5 g of emulsifier 2 and 0.2 g of NaHCO₃, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a), 0.5 g of TEGOPREN® 5840 and 5.0 g of TEGOPREN® 3110 are added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 1.0 g of ACTICIDE® MBS is added, and the mixture is stirred at 1000 rpm at 400 mbar for a further 10 min. Thereafter, the formulation is dispensed.

### Example 5

a) Organosiloxane:

At room temperature, a glass flask is initially charged with 1317.26 g of Protectosil® 286, 882.74 g of Dynasylan® OCTEO, 32.50 g of water, 144.30 g of D5 and 44.48 g of neopentyl glycol. At room temperature. 2.81 g or tetrabutylammonium hydroxide (40% in water) and 1.40 g or trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 60° C. After filtration, a colourless clear product having a viscosity of 26 mPa·s is obtained.

b) Bulk Hydrophobizing Agent:

A jacketed temperature-controlled 2 l stirred glass vessel is initially charged with 32.5 g of demineralized water. 15.0 g of emulsifier 1, 7.5 g or emulsifier 2 and 0.2 g of NaHCO₃, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a), 0.5 g of TEGOPREN® 5840 and 5.0 g of TEGOPREN® 3110 are added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 1.0 g of ACTICIDE® MBS is added, and the mixture is stirred at 1000 rpm at 400 mbar for a further 10 min. Thereafter, the formulation is dispensed.

### Example 6

a) Organosiloxane:

At room temperature, a glass flask is initially charged with 877.19 g of Protectosil® 268 (distilled), 438.60 g of Dynasylan® OCTEO, 87.72 g of D5, 4.39 g of 0.5% sulfuric acid, and heated to 80° C. At that temperature, 43.88 g of ethanol is added dropwise within 20 min and the mixture is stirred for a further 30 minutes. This is followed by cooling to 50° C. and dropwise addition of 43.88 g of water within 3 minutes. After stirring for two hours, 4.39 g of a 0.5% sodium carbonate solution is added and the mixture is stirred for a further 10 minutes. Then the mixture is heated to 115° C. and the vessel is evacuated to p<10 mbar. After distillation for one hour, the mixture is cooled to 60° C. and filtered. After filtration, a colourless clear product having a viscosity of 9 mPa·s is obtained.

b) Bulk Hydrophobizing Agent (BHA):

A jacketed temperature-controlled 2 l stirred glass vessel is initially charged with 32.5 g of demineralized water, 15.0 g of emulsifier 1, 7.5 g of emulsifier 2, 0.2 g of NaHCO₃ and 0.5 g ACTICIDE® B 20, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a) is added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 0.5 g of ACTICIDE® MV is added, and the mixture is stirred at 1000 rpm at 400 mbar for a further 10 min. Thereafter, the formulation is dispensed.

### Comparative Example 1

Bulk Hydrophobizing Agent (BHA):

TEGOSIVIN® HE 328 (Evonik Operations GmbH): Silane/siloxane-based hydrophobizing agent

### Comparative Example 2

Bulk Hydrophobizing Agent (BHA):

TEGOSIVIN® CA 880 (Evonik Operations GmbH): Silane-based hydrophobizing agent

### Comparative Example 3

a) Organosiloxane:

At room temperature, a glass flask is initially charged with 2441.40 g of Protectosil® 266, 40.15 g of water, 178.29 g of D5 and 40.15 g of propylene glycol. At room temperature, 3.13 g of tetrabutylammonium hydroxide (40% in water) and 1.57 g of trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 60° C. and 127.68 g of silicone oil 1000 is added and stirred in for 30 min. After filtration, a colourless clear product having a viscosity of 168 mPa·s is obtained.

b) Bulk Hydrophobizing Agent (BHA)

A Jacketed temperature-controlled 2 l stirred glass vessel is initially charged with 32.5 g of demineralized water, 15.0 g of emulsifier 1, 7.5 g of emulsifier 2, 0.2 g of NaHCO₃ and 0.5 g ACTICIDE® 20, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a) is added dropwise and incorporated at 400 mbar over a period of 15 min. On completion of addition, stirring is continued at 15-30° C. at 2000 rpm at 400 mbar for 15 min. This is followed by dropwise addition or 193.9 g of demineralized water at 400 mbar within 10 min. In the course of this, the stirrer speed is reduced gradually to 1000 rpm. 0.5 g of ACTICIDE® MV is added, and the mixture is stirred at 1000 rpm at 400 mbar for a further 10 min. Thereafter, the formulation is dispensed.

### Comparative Example 4

a) Organosiloxane:

At room temperature, a glass flask is initially charged with 250220 g of Dynasylan®@OCTEO, 30.71 g of water, 138.38 g of D5 and 30.71 g of propylene glycol. At room temperature. 3.13 g of tetrabutylammonium hydroxide (40% in water) and 1.57 g of trifluoromethanesulfonic acid are added successively while stirring, and the mixture is stirred for 1 h. This is followed by heating to 85° C. and stirring for 4 h. Then the mixture is exhaustively distilled at 100° C. and standard pressure. When no further distillate is obtained, the mixture is neutralized by introducing ammonia until a pH>8 has been attained. Then the temperature is increased to 115° C. and exhaustively distilled under reduced pressure (p<10 mbar) for a further hour. Then the mixture is cooled to 60° C. and 108.61 g of silicone oil 1000 is added and stirred in for 30 min. After filtration, a colourless clear product having a viscosity of 8 mPa·s is obtained.

b) Bulk Hydrophobizing Agent (BHA):

A jacketed temperature-controlled 2 l stirred glass vessel is initially charged with 32.5 g of demineralized water, 15.0 g of emulsifier 1, 7.5 g or emulsifier 2, 0.2 g of NaHCO₃ and 0.5 g ACTICIDE® 20, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 250.0 g of the product described in a) is added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 0.5 g of ACTICIDE® MV is added, and the mixture is stirred at 1000 rpm at 400 mbar for a further 10 min. Thereafter, the formulation is dispensed.

### Comparative Example 5

Bulk Hydrophobizing Agent in Accordance with EP 3 243 807 A1 (BHA):

A jacketed temperature-controlled 2 l stirred glass vessel is initially charged with 32.5 g of demineralized water, 15.0 g of emulsifier 1, 7.5 g of emulsifier 2, 0.2 g of NaHCO₃ and 0.5 g ACTICIDE® B 20, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 125.0 g of Protectosil® 266 and 125.0 g of Dynasylan® OCTEO are added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 0.5 g of Acticide MV is added, and the mixture is stirred at 1000 rpm at 400 mbar for a further 10 min. Thereafter, the formulation is dispensed.

### Comparative Example 6

Bulk Hydrophobizing Agent in Accordance with CN 103819127 a (BHA):

A jacketed temperature-controlled 2 l stirred glass vessel is initially charged with 32.5 g of demineralized water, 15.0 g of emulsifier 1, 7.5 g of emulsifier 2, 0.2 g of NaHCO₃ and 0.5 g ACTICIDE® B 20, and the contents are mixed together with a toothed disc (Ø=80 mm) at 1000 rpm at room temperature at 400 mbar for five minutes. In order to counteract any rise in temperature of the formulation, the glass vessel is cooled and the temperature of the contents are kept within a temperature range of 15-30° C. The stirrer speed is increased to 2000 rpm, and 75.0 g of MTES-HARZ 200 and 175.0 g of Dynasylan® OCTEO are added dropwise and incorporated at 400 mbar over a period of 15 min. On completion of addition, stirring is continued at 15-30° C. at 2000 rpm at 400 mbar for 15 min. This is followed by dropwise addition of 193.9 g of demineralized water at 400 mbar within 10 min. In the course of this, the stirrer speed is reduced gradually to 1000 rpm. 0.5 g of ACTICIDE® MV is added, and the mixture is stirred at 1000 rpm at 400 mbar for a further 10 min. Thereafter, the formulation is dispensed.

Performance Testing:

1. Determination of Dilution Stability

The formulations of inventive examples 1 to 6 (B1 to B6) and comparative examples 1 to 6 (V1 to V6) were used to produce 5%, 10% and 20% dilutions by blending with demineralized water. The dilutions were examined visually for stability immediately and every week in front of a light source. For better assessment, a 100 ml scaled measuring cylinder served as sample vessel. In general: the higher the dilution of an emulsion, the more marked the tendency to separation.

TABLE 1
Results of visual assessment* of the dilutions
over time (in weeks (W); 0 W = immediately)

| | Dilution** | 0 W | 1 W | 2 W | 3 W | 4 W | 5 W | 10 W | 11 W | 12 W |
|---|---|---|---|---|---|---|---|---|---|---|
| B1 | 5% | A | A | A | A | A | A | A | A | A |
| | 10% | A | A | A | A | A | A | A | A | A |
| | 20% | A | A | A | A | A | A | A | A | A |
| B2 | 5% | A | A | A | A | A | A | A | A | A |
| | 10% | A | A | A | A | A | A | A | A | A |
| | 20% | A | A | A | A | A | A | A | A | A |
| B3 | 5% | A | A | A | A | A | A | A | A | A |
| | 10% | A | A | A | A | A | A | A | A | A |
| | 20% | A | A | A | A | A | A | A | A | A |
| B4 | 5% | A | A | A | A | A | A | A | A | A |
| | 10% | A | A | A | A | A | A | A | A | A |
| | 20% | A | A | A | A | A | A | A | A | A |
| B5 | 5% | A | A | A | A | A | A | A | A | A |
| | 10% | A | A | A | A | A | A | A | A | A |
| | 20% | A | A | A | A | A | A | A | A | A |
| B6 | 5% | A | A | A | A | A | A | A | A | A |
| | 10% | A | A | A | A | A | A | A | A | A |
| | 20% | A | A | A | A | A | A | A | A | A |
| V1 | 5% | A | B | C | C | C | C | C | C | C |
| | 10% | A | B | B | C | C | C | C | C | C |
| | 20% | A | A | B | C | C | C | C | C | C |
| V2 | 5% | A | B | C | C | C | C | C | C | C |
| | 10% | A | B | B | C | C | C | C | C | C |
| | 20% | A | A | B | C | C | C | C | C | C |
| V3 | 5% | A | B | B | B | B | B | B | B | B |
| | 10% | A | A | A | A | A | A | B | B | B |
| | 20% | A | A | A | A | A | A | B | B | B |
| V4 | 5% | A | B | B | B | B | B | B | B | B |
| | 10% | A | B | B | B | B | B | B | B | B |
| | 20% | A | A | A | A | A | A | A | A | A |
| V5 | 5% | A | B | B | B | B | B | B | B | B |
| | 10% | A | B | B | B | B | B | B | B | B |
| | 20% | A | A | A | A | A | A | B | B | B |
| V6 | 5% | A | B | B | B | B | B | B | B | B |
| | 10% | A | B | B | B | B | B | B | B | B |
| | 20% | A | A | A | A | A | A | A | A | A |

*Assessment scheme:
A: homogeneous, no signs of separation
B: creaming, streak formation
C: thinning (>3 ml)
**x % = x parts by weight of BHA per 100 parts by weight of dilution

The results show clearly that the inventive examples, even in the case of high dilutions and over a period of 3 months, do not show any tendency to demixing or separation in the form of thinning or creaming, whereas the comparative examples show creaming or steak formation at concentrations ≤10% even after one week.

2. Composition and Production of the Test Specimens

For determination of fresh and set mortar properties, mortar is produced in accordance with DIN EN 196-1 (2016).

TABLE 2
Composition of the mortar mixtures

| CEM I 42.5 R | 450 g |
|---|---|
| Standard sand (DIN EN 196-1) | 1350 g |
| Water | 225 g |
| Bulk hydrophobizing agent (BHA) | 0.5%/1%* |

*Supply form based on cement content (x% = x parts by weight of BHA based on 100 parts by weight of cement in the composition)

The bulk hydrophobizing agents were added to the added water. Apart from Comparative Example 2, they were present with an active content of 50%. Comparative Example 2 had an active content of 60%. A blank mixture without addition of a bulk hydrophobizing agent served as comparison. Alter 24 hours, the mortar specimens (40·40·160 mm³) were taken out of the mould and stored under conditions of 23° C./50% relative humidity until the test date.

3. Determination of Fresh Mortar Properties

The formulations of Examples 1 to 6 and of Comparative Examples 1 to 6 were used to determine the following fresh mortar properties in accordance with DIN 18555-2 (1982): Consistency, bulk density and air content.

TABLE 3
Fresh mortar properties

| | BHA dosage | Slump | Air content | Bulk density |
|---|---|---|---|---|
| | [%] | [mm] | [%] | [kg/dm³] |
| Blank | — | 178 | 5.8 | 2184.4 |
| mixture | | | | |
| B1 | 0.5 | 184 | 4.5 | 2187.5 |
| | 1 | 185 | 4.5 | 2186.1 |
| B2 | 0.5 | 181 | 4.6 | 2188.0 |
| | 1 | 181 | 4.6 | 2180.7 |
| B3 | 0.5 | 176 | 5.4 | 2207.0 |
| | 1 | 177 | 5.5 | 2191.4 |
| B4 | 0.5 | 180 | 6.2 | 2186.0 |
| | 1 | 180 | 6.1 | 2179.5 |
| B5 | 0.5 | 172 | 5.6 | 2205.0 |
| | 1 | 173 | 5.6 | 2212.3 |
| B6 | 0.5 | 183 | 4.5 | 2187.6 |
| | 1 | 184 | 4.3 | 2193.5 |
| V1 | 0.5 | 183 | 5.4 | 2167.9 |
| | 1 | 187 | 5.1 | 2177.5 |
| V2 | 0.5 | 182 | 6.4 | 2176.0 |
| | 1 | 184 | 6.2 | 2188.7 |
| V3 | 0.5 | 183 | 5.2 | 2171.2 |
| | 1 | 184 | 4.8 | 2181.9 |
| V4 | 0.5 | 175 | 4.4 | 2194.1 |
| | 1 | 177 | 4.6 | 2186.9 |
| V5 | 0.5 | 185 | 4.0 | 2198.0 |
| | 1 | 188 | 4.3 | 2194.6 |
| V6 | 0.5 | 176 | 4.5 | 2191.4 |
| | 1 | 182 | 4.1 | 2198.1 |

4. Determination of Capillary Water Absorption

The method serves to assess the intensity of water absorption owing to capillary forces. The procedure is in accordance with DIN EN ISO 15148 (2018). The specimens with dimensions of 40·40·160 mm³ are stored under standard conditions of 23° C./50% rel. air humidity for 28 days. They are then weighed (laboratory balance. 0.1 g display) and placed by their underside onto two metal brackets in a water bath, such that free access of water to the underside is possible. The water level should lie (5±2) mm above the lower edge of the prisms. After 24 hours, the specimens are weighed again, after water adhering to the surface has been removed with an absorptive paper towel. Water absorption is calculated as follows:

$$WA = \frac{m 2 \cdot 100}{m 1} - 100$$

WA: Water absorption in %
m1: Mass of the specimen in g before storage in water
m2: Mass of the specimen in g after storage in water

The results in Table 4 are each the average from three single determinations.

TABLE 4
Results of the determination of capillary water
absorption [%] after 24 hours

| | 0% BHA | 0.5% BHA* | 1% BHA* |
|---|---|---|---|
| Blank mixture | 4.2 | — | — |
| B1 | | 0.8 | 0.5 |
| B2 | | 0.8 | 0.5 |
| B3 | | 1.3 | 0.5 |
| B4 | | 1.6 | 0.6 |
| B5 | | 1.7 | 0.6 |
| B6 | | 1.1 | 0.5 |
| V1 | | 1.1 | 0.5 |
| V2 | | 1.2 | 0.5 |
| V3 | | 1.4 | 0.9 |
| V4 | | 0.9 | 0.5 |
| V5 | | 1.0 | 0.6 |
| V6 | | 1.0 | 0.5 |

*Dosage based on cement (x% = x parts by weight of BHA based on 100 parts by weight of cement in composition)

5. Determination of Flexural Tensile Strength and Compressive Strength

Flexural tensile strength and compressive strength of the mortar specimens of dimensions 40·40·160 mm³ were determined after the respective storage time. Testing was conducted according to DIN EN 196-1 (2016) with a testing press from Toni Technik, model: ToniPRAX. The results in Table 5 are each the average from three single determinations.

TABLE 5
Results of determinations of flexural tensile strength
and compressive strength after 1 and 28 days.

| | | Compressive strength | | Flexural tensile strength | |
|---|---|---|---|---|---|
| | BHA dosage | [N/mm²] | | [N/mm²] | |
| | [%] | 1 day | 28 days | 1 day | 28 days |
| Blank | — | 19.7 | 37.3 | 4.4 | 7.1 |
| mixture | | | | | |
| B1 | 0.5 | 20.6 | 38.5 | 5.1 | 8.1 |
| | 1 | 19.6 | 38.7 | 4.9 | 8.0 |
| B2 | 0.5 | 20.7 | 39.5 | 5.1 | 8.5 |
| | 1 | 19.9 | 37.3 | 4.5 | 8.5 |
| B3 | 0.5 | 21.0 | 41.6 | 5.5 | 9.0 |
| | 1 | 21.4 | 40.5 | 4.9 | 8.7 |
| B4 | 0.5 | 19.9 | 39.4 | 5.1 | 9.5 |
| | 1 | 19.2 | 39.6 | 5.3 | 8.8 |
| B5 | 0.5 | 24.3 | 40.0 | 5.3 | 10.0 |
| | 1 | 22.8 | 40.4 | 5.1 | 9.7 |
| B6 | 0.5 | 20.6 | 39.2 | 4.9 | 8.1 |
| | 1 | 19.8 | 39.2 | 4.9 | 8.9 |
| V1 | 0.5 | 22.1 | 38.5 | 5.2 | 8.3 |
| | 1 | 21.2 | 38.7 | 5.2 | 7.9 |
| V2 | 0.5 | 19.6 | 33.9 | 5.0 | 8.8 |
| | 1 | 18.5 | 34.2 | 4.6 | 8.5 |
| V3 | 0.5 | 18.7 | 37.5 | 3.7 | 8.7 |
| | 1 | 19.3 | 35.8 | 4.0 | 8.5 |
| V4 | 0.5 | 20.6 | 39.2 | 5.3 | 7.9 |
| | 1 | 18.8 | 40.5 | 4.5 | 7.9 |
| V5 | 0.5 | 19.7 | 39.1 | 4.7 | 7.5 |
| | 1 | 18.9 | 38.0 | 4.9 | 7.8 |
| V6 | 0.5 | 19.3 | 39.7 | 4.7 | 7.5 |
| | 1 | 16.6 | 38.4 | 4.3 | 9.1 |

The fresh and set mortar properties (capillary water absorption, strengths) are not significantly affected by the addition of the inventive bulk hydrophobizing agents B1 to B6 by comparison with the noninventive bulk hydrophobizing agents V1 to V6. Both the inventive and noninventive bulk hydrophobizing agents show better properties than the blank mixture.

1: A composition, comprising:
at least one organosiloxane (A),
at least one emulsifier (B), and
water,
wherein the at least one organosiloxane (A) has SiC-bonded C₂-C₆-alkyl radicals and SiC-bonded C₇-C₁₈-alkyl radicals.

2: The composition according to claim 1, wherein the composition is an emulsion.

3: The composition according to claim 1, wherein the SiC-bonded C₂-C₆-alkyl radicals and the SiC-bonded C₇-C₁₈-alkyl radicals comprise propyl radicals and octyl radicals.

4: The composition according to claim 1, wherein the at least one organosiloxane (A) contains units of the formula
R¹Si(OR²)ₙO_{(3-a)/2} (I), and
optionally, units of the formula
R³₂Si(OR²)_{b}O_{(2-b)/2} (II),
in which
R¹ is a C₂-C₆-alkyl radical or a C₇-C₁₈-alkyl radical, with the proviso that the at least one organosiloxane (A) contains, as R¹ radicals, both C₂-C₆-alkyl radicals and C₇-C₁₈-alkyl radicals;
R² is a C₁-C₄-alkyl radical, or a hydrogen atom or a radical of the formula —[YO]ₙZ
wherein
Y is a C₂-C₁₀-alkylene radical,
n is an integer from 1 to 10, and
Z is a hydrogen atom or a bond to a silicon atom;
R³ is a C₁-C₄-alkyl radical,
a is 0, 1 or 2;
b is 0 or 1.

5: The composition according to claim 4, wherein the at least one organosiloxane (A), based on total number of units of the formula (I) and (II), contains at least 50 mol % of units of the formula (I), and not more than 50 mol %, of units of the formula (II).

6: The composition according to claim 1, wherein the at least one organosiloxane (A) contains, in parts by mass based on a total mass,
20% to 80% of the SiC-bonded C₂-C₆-alkyl radicals, and
30% to 40% of the SiC-bonded C₇-C₁₈-alkyl radicals.

7: The composition according to claim 1, wherein the at least one organosiloxane (A) is preparable by a process comprising converting a reaction mixture composed of
i. at least one C₂-C₆-alkylalkoxysilane and/or at least one C₂-C₆-alkylalkoxysiloxane,
ii. at least one C₇-C₁₈-alkylalkoxysilane and/or at least one C₇-C₁₈-alkylalkoxysiloxane,
iii. water,
iv. optionally, at least one mono- or polyfunctional C₂-C₁₀ alcohol,
v. optionally, at least one cyclic dimethylsiloxane,
vi. optionally, at least one tetraalkylammonium hydroxide,
vii. optionally, at least one superacid, and
viii. optionally, further substances.

8: The composition according to claim 1, wherein the at least one emulsifier (B) is a nonionic emulsifier.

9: The composition according to claim 1, wherein the composition comprises at least one organosiloxane (C) other than the at east one organosiloxane (A).

10: The composition according to claim 1, wherein the composition contains, based in each case on a total mass of the composition, the following constituents:
the at least one organosiloxane (A) in a proportion by mass of 10% to 80%,
the at least one emulsifier (B) in a total proportion by mass of 1.5% to 15%,
one or more organosiloxanes (C) in a proportion by mass of 0% to 30%,
one or more additives (D) in a proportion by mass of 0% to 25%, and
water in such a proportion by mass that a sum total of proportions by mass of all constituents is 100%.

11: A process for preparing organosiloxanes (A), the process comprising:
converting a reaction mixture composed of
i. at least one C₂-C₆-alkylalkoxysilane and/or at least one C₂-C₆-alkylalkoxysiloxane,
ii. at least one C₇-C₁₈-alkylalkoxysilane and/or at least one C₇-C₁₈-alkylalkoxysiloxane,
iii. water,
iv. optionally, at least one mono- or polyfunctional C₂-C₁₀ alcohol,
v. optionally, at least one cyclic dimethylsiloxane,
vi. at least one tetraalkylammonium hydroxide,
vii. at least one superacid, and
viii. optionally, further substances.

12: A method, comprising:
adding the composition according to claim 1 as a dilution-stable hydrophobizing agent to a mixture comprising a mineral construction material or an organic construction material.

13: A hydraulically setting composition, comprising the following components:
a) at least one hydraulic binder,
b) at least one composition according to claim 1,
c) optionally, at least one admixture selected from the group consisting of sand, gravel, limestone, and chalk, and
d) optionally, additional water.

14: The hydraulically setting composition according to claim 13, wherein the hydraulically setting composition comprises
100 parts by weight of component a),
0.1 to 10 parts by weight of component b),
100 to 600 parts by weight of component c), and
20 to 100 parts by weight of component d).

15: The hydraulically setting composition according to claim 13, wherein the hydraulically setting composition is a mortar, a screed, or a concrete.

16: The composition according to claim 2, wherein the composition is an oil-in-water emulsion.

17: The composition according to claim 5, wherein the at least one organosiloxane (A) comprises at least 70 mol % of units of the formula (I), and not more than 30 mol % of units of the formula (II), based on the total number of units of the formula (I) and (II).

18: The composition according to claim 6, wherein the at least one organosiloxane (A) contains, in parts by mass based on the total mass:
40% to 60% of the SiC-bonded C₂-C₆-alkyl radicals, and
20% to 30% of the SiC-bonded C₇-C₁₈-alkyl radicals.

19: The composition according to claim 8, wherein the at least one emulsifier (B) is an alkoxylated alcohol or an alkoxylated carboxylic acid.

20: The composition according to claim 9, wherein the at least one organosiloxane (C) is an α,ω-dihydroxypolydimethylsiloxane and/or an α,ω-dimethylpolydimethylsiloxane.
